(19) United States
(12) Patent Application Publication
(10) Pub. No.: US 2024/0114450 A1
(43) Pub. Date: Apr. 4, 2024

(54) ADAPTABLE DISCONTINUOUS RECEPTION CYCLES

(71) Applicant: QUALCOMM Incorporated, San Diego, CA (US)

(72) Inventors: Ahmed Elshafie, San Diego, CA (US); Diana Maamari, San Diego, CA (US); Huilin Xu, Temecula, CA (US)

(21) Appl. No.: 17/959,980

(22) Filed: Oct. 4, 2022

(51) Int. Cl. H04W 52/02; H04W 76/28

(52) U.S. Cl. CPC H04W 52/0229; H04W 76/28

(57) ABSTRACT

Methods, systems, and devices for wireless communications are described. A user equipment (UE) may be instructed to, or may autonomously determine to, extend a monitoring time period (e.g., by extending the on duration to cover more downlink transmissions, or by extending the on duration and continuing to monitor after on durations, or both). In some examples, a wakeup signal (WUS) or a downlink control information (DCI) message may explicitly indicate an amount of time to extend the on duration or inactivity timer (or to pause the inactivity timer). In some examples, the network may configure the UE with a power threshold (e.g., charging rate, discharging rate, energy harvesting rate, current power levels, or power headroom), or a traffic rate (e.g., number of transport blocks per time interval), and the UE may autonomously extend the on duration or timer if its energy levels or traffic rate exceeds the threshold.

### TECHNICAL FIELD

The following relates to wireless communications, including adaptable discontinuous reception (DRX) cycles.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support adaptable discontinuous reception (DRX) cycles. For example, a user equipment (UE) may be instructed to, or may autonomously determine to, extend a monitoring time period (e.g., by extending the on duration to cover more downlink transmissions, or by extending the on duration and continuing to monitor after on durations, or both). In some examples, a wakeup signal (WUS) or a downlink control information (DCI) message may explicitly indicate an amount of time to extend the on duration or inactivity timer (or to pause the inactivity timer). In some examples, the network may configure the UE with a power threshold (e.g., charging rate, discharging rate, energy harvesting rate, current power levels, power headroom), or a traffic rate (e.g., number of transport blocks per time interval), and the UE may autonomously extend the on duration or timer if its energy levels or traffic rate exceeds the threshold. In some examples, the UE may extend the monitoring time period to the greater of the inactivity timer or an amount of time between a scheduling DCI and a last symbol of a scheduled physical downlink shared channel (PDSCH) (e.g., or to a last PDSCH of an application data unit (ADU)). The UE may extend the monitoring time period by extending an on duration for a DCI received during the on duration, and may then extend or modify the inactivity timer every time another physical downlink control channel (PDCCH) is received during the extended on duration or extended inactivity timer. In some examples, the UE may periodically re-negotiate on durations or an inactivity timer duration with the network based on current or historic traffic patterns, energy levels, or both.

A method for wireless communications at a user equipment (UE) is described. The method may include receiving control signaling indicating a first on duration of a discontinuous reception cycle, extending, based on a detected trigger, a monitoring time period associated with the first on duration, the extending including modifying the first on duration, modifying an inactivity timer associated with the first on duration, or a combination thereof, and receiving one or more downlink messages during the extended monitoring time period.

An apparatus for wireless communications at a UE is described. The apparatus may include a processor, memory coupled with the processor, and instructions stored in the memory. The instructions may be executable by the processor to cause the apparatus to receive control signaling indicating a first on duration of a discontinuous reception cycle, extend, based on a detected trigger, a monitoring time period associated with the first on duration, the extending including modifying the first on duration, modifying an inactivity timer associated with the first on duration, or a combination thereof, and receive one or more downlink messages during the extended monitoring time period.

Another apparatus for wireless communications at a UE is described. The apparatus may include means for receiving control signaling indicating a first on duration of a discontinuous reception cycle, means for extending, based on a detected trigger, a monitoring time period associated with the first on duration, the extending including modifying the first on duration, modifying an inactivity timer associated with the first on duration, or a combination thereof, and means for receiving one or more downlink messages during the extended monitoring time period.

A non-transitory computer-readable medium storing code for wireless communications at a UE is described. The code may include instructions executable by a processor to receive control signaling indicating a first on duration of a discontinuous reception cycle, extend, based on a detected trigger, a monitoring time period associated with the first on duration, the extending including modifying the first on duration, modifying an inactivity timer associated with the first on duration, or a combination thereof, and receive one or more downlink messages during the extended monitoring time period.

Some examples of the method, apparatuses, and non-transitory computer-readable medium described herein may further include operations, features, means, or instructions for receiving a first wakeup signal including the detected trigger, the first wakeup signal associated with the first on duration and including an indication of a time interval where extending the monitoring time period includes extending the monitoring time period according to the indication of the time interval.

Some examples of the method, apparatuses, and non-transitory computer-readable medium described herein may further include operations, features, means, or instructions for receiving a control message, the control message including a first wakeup signal associated with the first on duration or a DCI message, and the control message further including an indication of a power threshold, where the detected trigger includes a determination that one or more parameters satisfy the power threshold, where the one or more parameters include a UE charging rate, a UE discharging rate, a UE energy level, a power headroom, or a combination thereof.

Some examples of the method, apparatuses, and non-transitory computer-readable medium described herein may further include operations, features, means, or instructions for measuring the one or more parameters prior to expiration of the inactivity timer, prior to an offset from an end of a previous on duration of the discontinuous reception cycle, prior to an offset from a beginning of the first on duration, based on a current energy state calculation, or any combination thereof.

Some examples of the method, apparatuses, and non-transitory computer-readable medium described herein may further include operations, features, means, or instructions for receiving control signaling indicating a communication state, the control signaling including the detected trigger, where extending the monitoring time period may be based on the communication state.

Some examples of the method, apparatuses, and non-transitory computer-readable medium described herein may further include operations, features, means, or instructions for receiving, during the first on duration, a DCI message including an indication of a time interval, the indication of the time interval including the detected trigger, where extending the monitoring time period includes extending the monitoring time period according to the indication of the time interval.

Some examples of the method, apparatuses, and non-transitory computer-readable medium described herein may further include operations, features, means, or instructions for receiving control signaling indicating a threshold ratio between a quantity of downlink messages and a quantity of time intervals and determining that a set of multiple downlink messages during the first on duration satisfies the threshold ratio, the determining including the detected trigger, where extending the monitoring time period may be based on receiving the set of multiple downlink messages.

Some examples of the method, apparatuses, and non-transitory computer-readable medium described herein may further include operations, features, means, or instructions for receiving, during the first on duration, a DCI message scheduling at least one message including an uplink message or a downlink message after the first on duration and selecting the greater of a first time period associated with the inactivity timer, or a second time period between reception of the DCI message and a last symbol of the scheduled at least one message, where extending the monitoring time period includes extending the monitoring time period according to the selecting.

Some examples of the method, apparatuses, and non-transitory computer-readable medium described herein may further include operations, features, means, or instructions for receiving, based on extending the monitoring time period, a second DCI message scheduling an additional message including an uplink message or a downlink message after the first on duration, selecting the greater of a time interval associated with the inactivity timer, or a third time period between reception of the second DCI message and a last symbol of the additional message, further extending the monitoring time period according to the selected time interval or the third time period, and communicating the additional message according to the further extended monitoring time period.

Some examples of the method, apparatuses, and non-transitory computer-readable medium described herein may further include operations, features, means, or instructions for extending the monitoring time period according to the selecting includes extending the on duration and further extending the monitoring time period according to the time interval associated with the inactivity timer or the third time period includes extending the inactivity timer.

Some examples of the method, apparatuses, and non-transitory computer-readable medium described herein may further include operations, features, means, or instructions for receiving, during the first on duration, a DCI message scheduling an application data unit including a set of multiple downlink transmissions where extending the monitoring time period includes extending the monitoring time period to a last symbol of a last downlink transmission of the set of multiple transmissions.

Some examples of the method, apparatuses, and non-transitory computer-readable medium described herein may further include operations, features, means, or instructions for receiving control signaling indicating an updated time interval for subsequent on durations of the discontinuous reception cycle, an updated time interval for the inactivity timer, or a combination thereof and monitoring for downlink signaling according to the updated time interval for the subsequent on durations, the updated time interval for the inactivity timer, or both.

Some examples of the method, apparatuses, and non-transitory computer-readable medium described herein may further include operations, features, means, or instructions for reporting one or more parameters associated with energy consumption at the UE, where receiving the control signaling indicating the updated time interval for each on duration, the updated time interval for the inactivity timer, or the combination thereof, may be based on reporting the one or more parameters.

A method for wireless communications at a network entity is described. The method may include transmitting, to a UE, control signaling indicating a first on duration of a discontinuous reception cycle and transmitting, to the UE, one or more downlink messages during an extended monitoring time period associated with a detected trigger, the extended monitoring time period including a modified on duration, a modified inactivity timer for the UE, or a combination thereof.

An apparatus for wireless communications at a network entity is described. The apparatus may include a processor, memory coupled with the processor, and instructions stored in the memory. The instructions may be executable by the processor to cause the apparatus to transmit, to a UE, control signaling indicating a first on duration of a discontinuous reception cycle and transmit, to the UE, one or more downlink messages during an extended monitoring time period associated with a detected trigger, the extended monitoring time period including a modified on duration, a modified inactivity timer for the UE, or a combination thereof.

Another apparatus for wireless communications at a network entity is described. The apparatus may include means for transmitting, to a UE, control signaling indicating a first on duration of a discontinuous reception cycle and means for transmitting, to the UE, one or more downlink messages during an extended monitoring time period associated with a detected trigger, the extended monitoring time period including a modified on duration, a modified inactivity timer for the UE, or a combination thereof.

A non-transitory computer-readable medium storing code for wireless communications at a network entity is described. The code may include instructions executable by a processor to transmit, to a UE, control signaling indicating a first on duration of a discontinuous reception cycle and transmit, to the UE, one or more downlink messages during an extended monitoring time period associated with a detected trigger, the extended monitoring time period including a modified on duration, a modified inactivity timer for the UE, or a combination thereof.

Some examples of the method, apparatuses, and non-transitory computer-readable medium described herein may further include operations, features, means, or instructions for transmitting a first wakeup signal including the detected trigger, the first wakeup signal associated with the first on duration and including an indication of a time interval, where the extended monitoring time period may be based on the indication of the time interval.

Some examples of the method, apparatuses, and non-transitory computer-readable medium described herein may further include operations, features, means, or instructions for transmitting a control message, the control message including a first wakeup signal associated with the first on duration or a DCI message, the control message further including an indication of a power threshold, where the detected trigger includes a determination that one or more parameters satisfy the power threshold, where the one or more parameters include a UE charging rate, a UE discharging rate, a UE energy level, a power headroom, or a combination thereof.

Some examples of the method, apparatuses, and non-transitory computer-readable medium described herein may further include operations, features, means, or instructions for transmitting control signaling indicating a communication state, the control signaling including the detected trigger, where the extended monitoring time period may be based on the communication state.

Some examples of the method, apparatuses, and non-transitory computer-readable medium described herein may further include operations, features, means, or instructions for transmitting control signaling indicating a threshold ratio between a quantity of downlink messages and a quantity of time intervals and determining that a set of multiple downlink messages during the first on duration satisfies the threshold ratio, the determining including the detected trigger, where the extended monitoring time period may be based on transmitting the set of multiple downlink messages.

Some examples of the method, apparatuses, and non-transitory computer-readable medium described herein may further include operations, features, means, or instructions for transmitting, during the first on duration, a DCI message scheduling at least one message including an uplink message or a downlink message after the first on duration, where the extended monitoring time period may be based on the greater of a first time period associated with the inactivity timer, or a second time period between reception of the DCI message and a last symbol of the scheduled at least one message.

Some examples of the method, apparatuses, and non-transitory computer-readable medium described herein may further include operations, features, means, or instructions for transmitting, based on the extended monitoring time period, a second DCI message scheduling an additional message including an uplink message or a downlink message after the first on duration, where the extended monitoring time period may be based on the greater of a time interval associated with the inactivity timer, or a third time period between reception of the second DCI message and a last symbol of the additional message and communicating the additional message according to the extended monitoring time period.

Some examples of the method, apparatuses, and non-transitory computer-readable medium described herein may further include operations, features, means, or instructions for transmitting, during the first on duration, a DCI message scheduling an application data unit including a set of multiple downlink transmissions where the extended monitoring time period includes a last symbol of a last downlink transmission of the set of multiple transmissions.

Some examples of the method, apparatuses, and non-transitory computer-readable medium described herein may further include operations, features, means, or instructions for transmitting control signaling indicating an updated time interval for subsequent on durations of the discontinuous reception cycle, an updated time interval for the inactivity timer, or a combination thereof and transmitting downlink signaling according to the updated time interval for the subsequent on duration, the updated time interval for the inactivity timer, or the combination thereof.

Some examples of the method, apparatuses, and non-transitory computer-readable medium described herein may further include operations, features, means, or instructions for receiving a report including one or more parameters associated with energy consumption at the UE, where transmitting the control signaling indicating the updated time interval for each on duration, the updated time interval for the inactivity timer, or the combination thereof, may be based on reporting the one or more parameters.

### BRIEF DESCRIPTION OF THE DRAWINGS

FIG. 1 illustrates an example of a wireless communications system that supports adaptable discontinuous reception (DRX) cycles in accordance with one or more aspects of the present disclosure.

FIG. 2 illustrates an example of a timeline that supports adaptable DRX cycles in accordance with one or more aspects of the present disclosure.

FIG. 3 illustrates an example of a timeline that supports adaptable DRX cycles in accordance with one or more aspects of the present disclosure.

FIG. 4 illustrates an example of a timeline that supports adaptable DRX cycles in accordance with one or more aspects of the present disclosure.

FIG. 5 illustrates an example of a timeline that supports adaptable DRX cycles in accordance with one or more aspects of the present disclosure.

FIG. 6 illustrates an example of a timeline that supports adaptable DRX cycles in accordance with one or more aspects of the present disclosure.

FIG. 7 illustrates an example of a timeline that supports adaptable DRX cycles in accordance with one or more aspects of the present disclosure.

FIG. 8 illustrates an example of a timeline that supports adaptable DRX cycles in accordance with one or more aspects of the present disclosure.

FIG. 9 illustrates an example of a process flow that supports adaptable DRX cycles in accordance with one or more aspects of the present disclosure.

FIGS. 10 and 11 show block diagrams of devices that support adaptable DRX cycles in accordance with one or more aspects of the present disclosure.

FIG. 12 shows a block diagram of a communications manager that supports adaptable DRX cycles in accordance with one or more aspects of the present disclosure.

FIG. 13 shows a diagram of a system including a device that supports adaptable DRX cycles in accordance with one or more aspects of the present disclosure.

FIGS. 14 and 15 show block diagrams of devices that support adaptable DRX cycles in accordance with one or more aspects of the present disclosure.

FIG. 16 shows a block diagram of a communications manager that supports adaptable DRX cycles in accordance with one or more aspects of the present disclosure.

FIG. 17 shows a diagram of a system including a device that supports adaptable DRX cycles in accordance with one or more aspects of the present disclosure.

FIGS. 18 through 21 show flowcharts illustrating methods that support adaptable DRX cycles in accordance with one or more aspects of the present disclosure.

### DETAILED DESCRIPTION

A user equipment (UE) may save power by operating according to a discontinuous reception (DRX) cycle (e.g., a connected mode DRX (CDRX) cycle), in which it periodically wakes up during an on duration (e.g., a DRX active time) to receive downlink signaling, and then goes back to sleep between on durations. The UE may also receive a wakeup signal (WUS) prior to on durations that will be used by a network entity to transmit downlink signaling. In some cases, the UE may receive control signaling during one or more physical downlink control channels (PDCCHs) received during the on duration, which may schedule downlink signaling (e.g., one or more physical downlink shared channels (PDSCHs) that extends beyond the end of an on duration. The UE may remain awake during an inactivity timer (e.g., an amount of time after receiving a PDCCH during an on duration to receive scheduled signaling outside of the on duration). However, due to jitter or other variance of the transmitting network entity, such as from bursty transmissions (e.g., an application data unit (ADU) including multiple PDSCHs), the UE may go back to sleep during off durations (e.g., even after expiration of the inactivity timer), and may miss downlink signaling. This failure to receive the downlink signaling may result in increased system latency, failed transmissions and increased retransmissions, increased delays, increased power expenditures, and less efficient use of system resources.

The UE may be instructed to, or may autonomously determine to, extend a monitoring time period (e.g., by extending the on duration to cover more downlink transmissions, or by extending the inactivity timer and continuing to monitor after on durations, or both). In some examples, a WUS or a downlink control information (DCI) may explicitly indicate an amount of time to extend the on duration or inactivity timer (or to pause the inactivity timer). In some examples, the network may configure the UE with a power threshold (e.g., charging rate, discharging rate, energy harvesting rate, current power levels, power headroom), or a traffic rate (e.g., number of transport blocks per time interval), and the UE may autonomously extend the on duration or timer if its energy levels or traffic rate exceeds the threshold.

In some examples, the UE may extend the monitoring time period to the greater of the inactivity timer or an amount of time between a scheduling DCI and a last symbol of a scheduled PDSCH (e.g., or to a last PDSCH of an ADU). The UE may extend the monitoring time period by extending an on duration for a DCI received during the on duration, and may then extend or modify the inactivity timer every time another PDCCH is received during the extended on duration or extended inactivity timer. In some examples, the UE may periodically re-negotiate on durations or an inactivity timer duration with the network based on current or historic traffic patterns, energy levels, or both.

Aspects of the disclosure are initially described in the context of wireless communications systems. Aspects of the disclosure are further illustrated by and described with reference to timelines and process flows. Aspects of the disclosure are further illustrated by and described with reference to apparatus diagrams, system diagrams, and flowcharts that relate to adaptable DRX cycles.

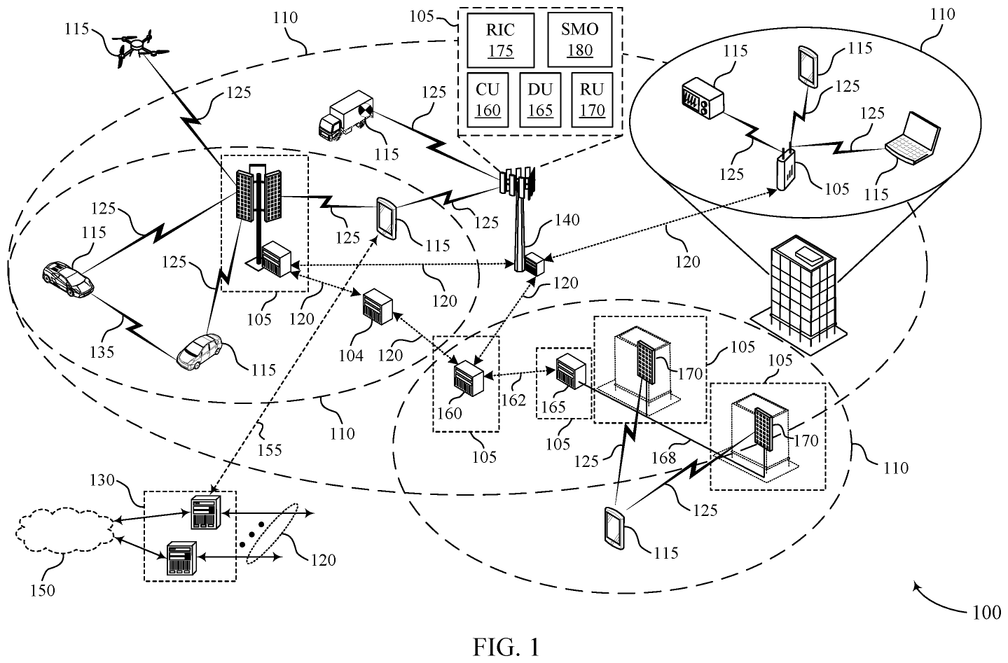

FIG. 1 illustrates an example of a wireless communications system 100 that supports adaptable DRX cycles in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, anode of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, among other examples, may include disclosure of the UE 115, network entity 105, apparatus, device, computing system, among other examples, being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support adaptable DRX cycles as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA),), a multimedia/entertainment device (e.g., a radio, a MP3 player, or a video device), a camera, a gaming device, a navigation/positioning device (e.g., GNSS (global navigation satellite system) devices based on, for example, GPS (global positioning system), Beidou, GLONASS, or Galileo, or a terrestrial-based device), a tablet computer, a laptop computer, a netbook, a smartbook, a personal computer, a smart device, a wearable device (e.g., a smart watch, smart clothing, smart glasses, virtual reality goggles, a smart wristband, smart jewelry (e.g., a smart ring, a smart bracelet)), a drone, a robot/robotic device, a vehicle, a vehicular device, a meter (e.g., parking meter, electric meter, gas meter, water meter), a monitor, a gas pump, an appliance (e.g., kitchen appliance, washing machine, dryer), a location tag, a medical/healthcare device, an implant, a sensor/actuator, a display, or any other suitable device configured to communicate via a wireless or wired medium. In some examples, a UE 115 may also refer to a wireless local loop (WLL) station, an Internet of Things (IoT) device, an Internet of Everything (IoE) device, or an MTC device, or the like, which may be implemented in various articles such as appliances, drones, robots, vehicles, meters, or the like.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging. In an aspect, techniques disclosed herein may be applicable to MTC or IoT UEs. MTC or IoT UEs may include MTC/enhanced MTC (eMTC, also referred to as CAT-M, Cat M1) UEs, NB-IoT (also referred to as CAT NB1) UEs, as well as other types of UEs. eMTC and NB-IoT may refer to future technologies that may evolve from or may be based on these technologies. For example, eMTC may include FeMTC (further eMTC), eFeMTC (enhanced further eMTC), and mMTC (massive MTC), etc., and NB-IoT may include eNB-IoT (enhanced NB-IoT), and FeNB-IoT (further enhanced NB-IoT).

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

A UE 115 may be instructed to, or may autonomously determine to, extend a monitoring time period (e.g., by extending the on duration to cover more downlink transmissions, or by extending the on duration and continuing to monitor after on durations, or both). In some examples, a WUS or a DCI may explicitly indicate an amount of time to extend the on duration or inactivity timer (or to pause the inactivity timer). In some examples, the network may configure the UE 115 with a power threshold (e.g., charging rate, discharging rate, energy harvesting rate, current power levels, or power headroom), or a traffic rate (e.g., number of transport blocks per time interval), and the UE 115 may autonomously extend the on duration or timer if its energy levels or traffic rate exceeds the threshold.

In some examples, the UE 115 may extend the monitoring time period to the greater of the inactivity timer or an amount of time between a scheduling DCI and a last symbol of a scheduled PDSCH (e.g., or to a last PDSCH of an ADU). The UE 115 may extend the monitoring time period by extending an on duration for a DCI received during the on duration, and may then extend or modify the inactivity timer every time another PDCCH is received during the extended on duration or extended inactivity timer. In some examples, the UE 115 may periodically re-negotiate on durations or an inactivity timer duration with the network based on current or historic traffic patterns, energy levels, or both.

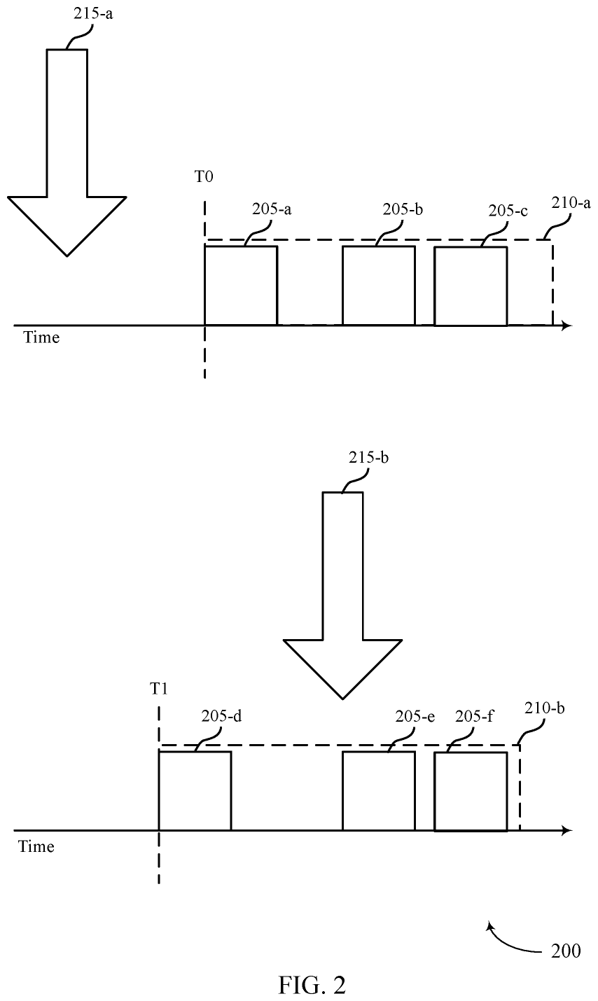

FIG. 2 illustrates an example of a timeline 200 that supports adaptable DRX cycles in accordance with one or more aspects of the present disclosure. Timeline 200 may implement, or be implemented by, aspects of wireless communications system 100. For example, a network entity (e.g., a network entity 105) and a UE (e.g., a UE 115), which may be examples of corresponding devices described with reference to FIG. 1, may communicate according to timeline 200.

Communications between a network entity and a UE may be inconsistent over time, resulting in increased expenditure of resources. For instance, downlink transmissions 205 may be bursty (e.g., may occur in groups, spaced out over time). In such examples, the network entity and the UE may communicate according to a DRX cycle (e.g., a CDRX). In such examples, the UE may go to sleep between on durations 210, but may wake up during on durations 210 to monitor for and receive downlink signaling (e.g., or transmit uplink signaling). In some examples, each on duration 210 may be associated with a WUS (e.g., the network entity may transmit a WUS during WUS resources indicating whether the UE is to wake up and communicate during a pending on duration 210).

In some examples, as described herein, the UE may be configured with an inactivity timer. An inactivity timer may define an amount of time for the UE to continue monitor for downlink signaling after receiving a DCI message scheduling downlink transmissions 205 during an on duration 210. For example, the DCI message may schedule a downlink transmission 205 that occurs at least partially outside of (e.g., after expiration of) an on duration 210. The UE may initiate the inactivity timer upon receiving the DCI during the on duration (e.g., or at the end of the on duration 210) and may continue to monitor for the scheduled PDSCH for the duration of the inactivity timer.

Such wireless communications may include, for instance, XR traffic. XR traffic may be quasiperiodic, and may deliver packets according to a non-integer periodicity (e.g., a periodicity of 16.67 ms, or sixty fps)). Non-integer periodicities may not match periodicity of a CDRX periodicity (e.g., a periodicity of on durations 210). Additionally, downlink traffic (e.g., XR traffic) may be transmitted according to a jitter (e.g., representing a core delay). The periodicity of the traffic, the jitter, or other transmission delays, may result in a mismatch between downlink transmissions 205 and on durations.

For example, XR downlink communications may include video frame transmissions. Video frames periodically arrive at or from a network entity. Arrival time may be subject to a random jitter (e.g., which may follow a truncated gaussian distribution with zero mean, 2 ms STD and a range of [−4, 4] ms). Variable frame size may also follow a truncated gaussian distribution. For instance, an AR or VR communication for thirty Mbps may have a threshold (e.g., minimum) packet size of 31250 bytes, a threshold (e.g., maximum) packet size of 93750 bytes, and a mean packet size of 62500 bytes. Such communications may result in five, ten, or fifteen slots for a 100 MHz bandwidth with a subcarrier spacing of 30 kHz, a modulation and coding scheme (MCS) of 16 QAM, and a ⅓ code rate. XR communications may also be submit to limited delay budgets for video frames. For instance, AR or VR communications may rely on a 10 ms threshold delay from the time when a video frame arrives at a network entity to the time the AR or VR communication is successfully transferred to the UE. Communications outside of such budgets may result in failed or interrupted service and reduced user experience.

Such reduced user experience may occur due to jitter, variable frame size, or periodicity of downlink signaling. In some examples, dynamic signaling (e.g., WUSs, or DCIs) may be relied on to indicate data arrival time, and a number of slots for a PDSCH in which to receive downlink transmissions 205. However, in some cases jitter, variable frame size, or periodic of the downlink signaling results in mismatch between on durations 210 and downlink transmissions 205. For instance, for on duration 210, the UE may expect a downlink transmission 205 (e.g., downlink transmission 205-a, downlink transmission 205-b, or downlink transmission 205-c) to occur at time T0. However, a jitter distribution may extend up to 6 or 7 ms prior to T0 or after T0. In such examples, an early burst arrival 215-a may occur (e.g., 7 ms prior to T0), which may be outside of the on duration 210-a. In such examples, the UE, the network entity, or both, may experience an increased delay at the downlink buffer.

Similarly, downlink transmissions 205 may arrive late. For instance, during on duration 210-b, the UE may monitor for downlink transmission 205-d, downlink transmission 205-e, and downlink transmission 205-f. The UE may expect downlink transmissions 205 (e.g., the downlink transmission 205-a) at time T1. however, due to a jitter distribution resulting in a delay or early transmission of, for instance, up to 5 ms, the UE may receive late burst arrival 215-b (e.g., after the expected arrival time at 215-b). In some examples, between time T1 and the late burst arrival 215-b, the UE may perform PDDCH monitoring (e.g., but not PDSCH monitoring). In such examples, the UE may miss some or all of the late burst arrival 215-b. In some examples, the late burst arrival 215-b may occur outside of an on duration 210, resulting in a missed transmission, failure to satisfy an XR latency budget, failed or retransmitted signaling, and decreased user experience.

To improve user experience, as described herein, the UE may adapt one or more CDRX parameters, including an inactivity timer duration, an on duration 210, or a combination thereof. Such adaptive parameters may match traffic periodicity to the DRX cycle, and may further address mismatches arising from jitter or other communication delays or timing issues. Additionally, or alternatively, such adaptive DRX cycles may result in power savings and more efficient use of wireless resources at wireless devices, and may be based on or assist in UE energy harvesting or power conserving techniques. For example, the UE may adjust an inactivity timer or an on duration 210 based on an amount of available energy, or a rate of energy harvesting or energy depletion, among other examples.

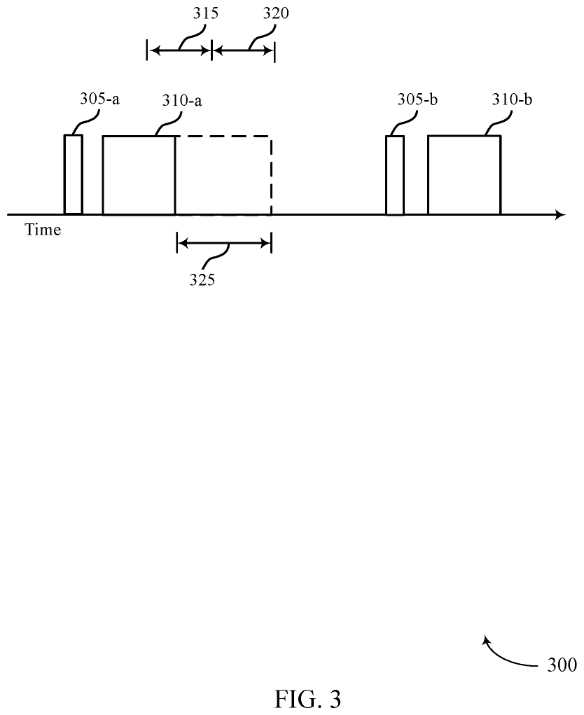

FIG. 3 illustrates an example of a timeline 300 that supports adaptable DRX cycles in accordance with one or more aspects of the present disclosure. Timeline 300 may implement, or be implemented by, aspects of wireless communications system 100 and timeline 200. For example, a network entity (e.g., a network entity 105) and a UE (e.g., a UE 115), which may be examples of corresponding devices described with reference to FIG. 1 and FIG. 2, may communicate according to timeline 300. The UE may communicate with the network entity according to a DRX cycle, where the UE is configured with one or more on durations 310 (e.g., on duration 310-a and on duration 310-b), and one or more WUS 305 (e.g., the WUS 305-a associated with the on duration 310-a and the WUS 305-b associated with the on duration 310-b).

The UE may also be configured with an inactivity timer 315. In such examples, the UE may wake up for on duration 310-a (e.g., based on receiving the WUS 305-a). The UE may receive a DCI message scheduling a downlink transmission, during the on duration 310-a, and may initiate the inactivity timer 315. The UE may then continue to monitor (e.g., at least for the scheduled downlink transmissions) after expiration of the on duration 310-a for the duration of the inactivity timer 315. The time period during which the UE monitors for downlink signaling may be referred to as a monitoring time period, or a monitoring time duration. The UE may dynamically or flexibly extend the monitoring time period (e.g., beyond the inactivity timer 315) by extending the inactivity timer 315 or by extending the on duration 310, as described in greater detail herein.

The UE may perform wireless communications according to an adaptive DRX cycle according to an indication from the network. The indication may include an explicit indication to extend an inactivity timer 315 or an on duration 310. For instance, the UE may receive, via the WUS 305-a, an indication to extend the inactivity timer 315 by an extension 320 (e.g., an offset of a number (e.g., X) of time intervals, such as a number of symbols or a number of slots). In such examples, the UE may continue to monitor for downlink signaling during the extended inactivity timer (e.g., which may be extended to include the extension 320). In some examples, the indication may include an indication to extend the on duration 310-a by time period 325, during which the UE may continue to monitor for downlink signaling.

In some examples, the UE may receive (e.g., via the WUS 305-a) an indication to extend the on duration 310-a or the inactivity timer 315 based on a power state (e.g., one or more energy conditions or energy thresholds) at the UE. For example, in the WUS 305-a, the network entity may indicate that the UE is to extend the inactivity timer 315 or the on duration 310 if a UE energy is higher than a threshold, or if a charging rate is higher than a threshold, or a discharging rate is lower than a threshold, or any combination thereof. In some examples, the network entity may configure the UE with the one or more thresholds via RRC signaling or MAC-CE, or may dynamically indicate the thresholds (e.g., via the WUS 305-a or via a DCI message during the on duration 310-a). In some example, the power states may be indicated to the UE via a subsequent DCI (e.g., in a second state WUS 305, or in another non-scheduling or scheduling DCI message). Power states may also include at least one of an energy state (e.g., a battery level), a charging rate (e.g., for energy harvesting devices, such as passive internet of things (IOT) devices), energy consumption rates, energy discharging rates, or any combination thereof. In some examples, a power state may be associated with a threshold for each quantity. For instance, there may be a threshold indicated (e.g., via RRC signaling, MAC-CE signaling, DCI signaling, or WUS signaling) for each (e.g., or multiple) energy metrics (e.g., a first threshold for battery level, a second threshold or energy discharging rate). IF one or more energy thresholds are satisfied (e.g., or if at least one energy threshold is satisfied), then the UE may extend the inactivity timer 315 or the on duration 310 (e.g., or both). The extension of the inactivity timer 315 or the on duration 310 may be based on RRC or MAC-CE configuration of energy thresholds, or energy states, or a communication state (e.g., without an explicit DCI message or WUS indicating the threshold or triggering the extension).

In some examples, a control message (e.g., a DCI message or a WUS) may include an indication to pause or freeze or hold an inactivity timer by a delta time offset (e.g., which may be configured via L1 signaling, L2 signaling, or L3 signaling). For instance, the network entity may indicate, to the UE, to pause the inactivity timer 315 for an amount of time equal to the extension 320. After pausing the inactivity timer, the UE may allow the inactivity timer to continue running until expiration (e.g., resulting in an extension of a monitoring time period until the end of extension 320).

In some examples, the network entity may transmit an indication to extend the inactivity timer 315 or the on duration 310 via a non-scheduling DCI message. The non-scheduling DCI message may define a time offset in the non-scheduling DCI to indicate a PDCCH skipping duration (e.g., a time period during which the UE may continue to monitor for PDSCH, PDCCH, or both).

In some examples, a DCI message may include a scheduling offset (e.g., K0) or a PDCCH skipping duration, which may be indicated by a PDCCH monitoring adaptation indication field. Such indications may indicate a duration for extending the inactivity timer 315 or the on duration 310. The PDCCH skipping duration may be used to indicate to the UE to stop monitoring PDCCH during a certain time within the DRX active time (e.g., during the on duration 310). However, in some examples, the UE may interpret the PDCCH skipping duration indicated in a DCI message to indicate an amount of time to extend the inactivity timer 315 or an amount of time to delay entering a sleep mode (e.g., extend the on duration 310). In some examples, an indication in the DCI message (e.g., K0 or K2 or a skipping PDCCH indication) may indicate the amount of time by which the UE is to extend the on duration 310 or the inactivity timer 315. The PDCCH skipping indication may be included in a scheduling DCI message.

In some examples, a DCI message may schedule a dummy PDSCH (e.g., may include one or more invalid fields) and may include the indication of how long to extend the on duration 310 or the inactivity timer 315. In some examples, the network entity may include such an indication in a final (e.g., last) scheduling DCI message within a DRX active time (e.g., the on duration 310-a). After the last DCI message, the UE may initiate the inactivity timer (e.g., according to the indication, including an extension 320). In some examples, a scheduling offset (e.g., K0 or K2) may be included in the scheduling DCI with dummy fields, and may be used as the indication of the extension. In some examples, one or more new or additional bits in a DCI message may be reserved to indicate the additional inactivity timer or extended wakeup time.

The UE may autonomously extend the monitoring time period (e.g., extend the inactivity timer 315 or on duration 310) based on one or more conditions being satisfied. For example, the network may configure the UE with one or more conditions, and if the conditions are satisfied (e.g., without a trigger received in a WUS or a DCI message), the UE may autonomously extend the monitoring time period (e.g., may extend the inactivity timer 315, the on duration 310, or both). For example, the UE may autonomously perform such an extension of the monitoring time period based on a density of data reception or an average data reception (e.g., over time) at the UE. Dense data arrival (e.g., a large number of data transmissions in a small amount of time) may indicate that more data arrival is likely to occur imminently (e.g., after expiration of the on duration 310-a). If a PDSCH arrival rate (e.g., or any signal type) is at or above a threshold number of transmissions (e.g., K TBs) per a number of time units (e.g., X symbols or slots), then the UE may autonomously extend the inactivity timer 315 or the on duration 310 by an amount Z (e.g., extension 320 or time period 325). Values for K, X, and Z may be configured at the UE via RRC signaling, MAC-CE signaling, or via WUS signaling or scheduling or non-scheduling DCI signaling.

In some examples, the UE may autonomously extend the monitoring time period based on whether UE energy satisfies a threshold. For example, the UE may extend the monitoring time period if it has enough (e.g., at least more than an amount of energy L, where L≥1, for processing PDSCHs, PDCCHs, or both. The UE may autonomously extend the monitoring time period if an energy arrival (e.g., charging rate) per a certain time unit (e.g., symbol or slot) satisfies a threshold L. The threshold L may be configured via RRC signaling, MAC-CE signaling, WUS signaling, or DCI signaling. In some examples, the UE may autonomously extend the monitoring time period if both sets of conditions are satisfied (e.g., if a signaling density rate satisfies a threshold, if an energy level or rate satisfies an energy threshold, or only if both thresholds are satisfied).

In some examples, extension of the monitoring time period (e.g., the on duration 310-a, the inactivity timer 315, or both) may be a function of energy available, energy charging rate, number of received PDSCH during a DRX active time, traffic information, or statistics indicated to or by the UE associated with downlink signaling, configured reference signals that the UE is to process (e.g., for transmission, reception, or both), during active or outside of active time periods, or any combination thereof. Such measured quantities may be used to compute an inactivity timer 315 or extension of the on duration 310. The UE may measure such quantities or parameters at the edge of each on duration 310, at the edge of extended monitoring time periods, before an offset from the end of a DRX active time, based on one or more factors (e.g., prediction of on charging rate, prediction of on energy states, prediction of discharging rates, predictions of energy consumption, among other examples). The UE may compute or measure such quantities at a time offset (e.g., X) before the end of a DRX active time.

Based on an energy state (e.g., a current energy state or a predicted energy state over time), and one or more of a power or energy consumption during one or more previous DRX active time periods, a charging rate profile (e.g., a current charging rate or an energy arrive or harvesting rate, a prediction of energy harvesting or arrival), a history of energy harvesting or charging rates, uplink or downlink traffic or statistics (e.g., current and predicted downlink and uplink traffic), or any combination thereof, the UE and the network entity may adjust DRX parameters (e.g., on duration size and duration, DRX parameters in general, inactivity timer durations, rules for extending on durations or timers). Such updates may be accomplished via L1, L2, or L3 signaling, or a combination thereof. Such updated DRX parameters may be applied to one or more uplink DRX cycles. In some cases, the updated DRX parameters may also indicate how many DRX cycles or periods of the DRX cycles are to be updated according to the updated DRX parameters (e.g., which may expire after a fixed time period or an indicated number of on durations or cycles), and after such a time period the DRX cycles may revert to a previous or default configuration. In some cases, during a current WUS, adjustments to the DRX cycle and on duration and inactivity timer may be provided, and applied across the current (e.g., next) DRX on duration 310-a associated with the WUS 305-a, or with multiple subsequent on durations 310.

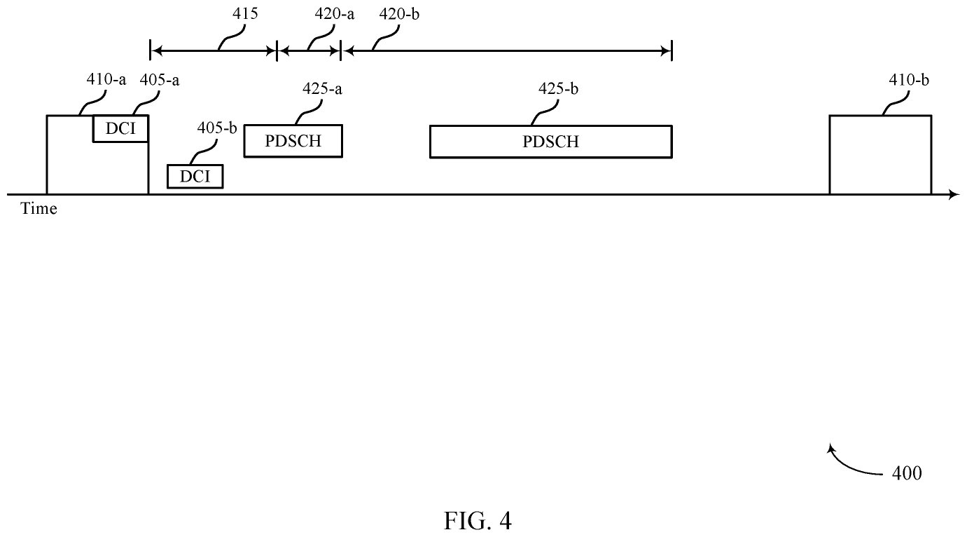

Extending the monitoring time period may include extending the inactivity timer 315 (e.g., by the extension 320), extending the on duration 310-a (e.g., by the time period 325), or a combination thereof, as described in greater detail with reference to FIGS. 4-7. Although illustrated and described with reference to PDSCH signaling, the techniques described herein may be similarly applied for uplink signaling during an extended DRX active time period (e.g., the UE may extend a DRX active time period for scheduled uplink signaling similar to techniques illustrated herein or extending a DRX active time period for scheduled downlink signaling).

FIG. 4 illustrates an example of a timeline 400 that supports adaptable DRX cycles in accordance with one or more aspects of the present disclosure. Timeline 400 may implement, or be implemented by, aspects of wireless communications system 100, timeline 200, and timeline 300. For example, a network entity (e.g., a network entity 105) and a UE (e.g., a UE 115), which may be examples of corresponding devices described with reference to FIGS. 1-3, may communicate according to timeline 400. The UE may communicate with the network entity according to a DRX cycle, where the UE is configured with one or more on durations 410 (e.g., on duration 410-a and on duration 410-b), and one or more WUSs (e.g., prior to each respective on duration 410). The UE may also be configured with an inactivity timer 415.

The UE may wake up during on duration 410-a and monitor for downlink signaling. The UE may receive (e.g., during the on duration 410-a) a DCI 405-a (e.g., based on PDCCH monitoring during the on duration 410-a). The DCI 405-a may schedule a downlink signal (e.g., a PDSCH 425-a) that is to occur after the on duration 410-a.

The UE may determine a monitoring time period (e.g., an extended monitoring time period, or a DRX active time) based on the greater (e.g., the maximum) of the inactivity timer 415 and an end (e.g., a last time interval, such as a last symbol or a last slot) of the scheduled PDSCH (e.g., the PDSCH 425-a, to be received outside of the on duration 410-a). In such examples, the UE may determine that a time period between the DCI 405-a and the end of the PDSCH 425-a is greater than the duration of the inactivity timer 415, and may extend the inactivity timer 415 by first extension 420-a (e.g., extending the duration of the inactivity timer until a last time interval of the scheduled PDSCH 425-a).

During the extended inactivity timer, the UE may perform PDCCH monitoring, and may extend the inactivity timer 415 further if any PDCCHs are received. For example, the UE may receive (e.g., based on the PDCCH monitoring during the inactivity timer 415) the DCI 405-b, which may schedule a downlink transmission (e.g., the PDSCH 425-b).

Having determined the end of the extended monitoring time period (e.g., DRX active time) to be at expiration of the first extension 420-a, the UE may restart or rest the inactivity timer (e.g., or use a modified version of the inactivity timer 415) whenever PDCCH is received during the extended monitoring time period (e.g., during the extended inactivity timer 415). For example, having received the DCI 405-b scheduling the PDSCH 425-b, the UE may determine whether the duration of the inactivity timer 415 is greater than a time period from the DCI 405-b (e.g., or from the expiration of the first extension 420-a) to the scheduled PDSCH 425-b. The UE may then extend the inactivity timer 415 again. For instance, the UE may extend the inactivity timer 415 further by the second extension 420-b (e.g., may extend the DRX active time until the end of the PDSCH 425-b scheduled by the DCI 405-b).

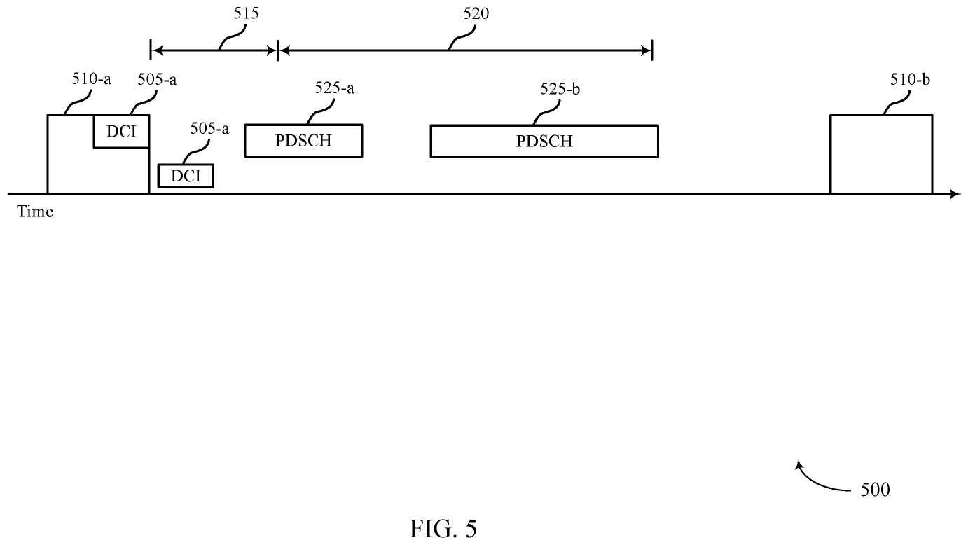

FIG. 5 illustrates an example of a timeline 500 that supports adaptable DRX cycles in accordance with one or more aspects of the present disclosure. Timeline 500 may implement, or be implemented by, aspects of wireless communications system 100, timeline 200, timeline 300, and timeline 400. For example, a network entity (e.g., a network entity 105) and a UE (e.g., a UE 115), which may be examples of corresponding devices described with reference to FIGS. 1-4, may communicate according to timeline 500. The UE may communicate with the network entity according to a DRX cycle, where the UE is configured with one or more on durations 510 (e.g., on duration 510-a and on duration 510-b), and one or more WUSs (e.g., prior to each respective on duration 510). The UE may also be configured with an inactivity timer 515.

The UE may wake up during on duration 510-a and monitor for downlink signaling. The UE may receive (e.g., during the on duration 510-a) a DCI 505-a (e.g., based on PDCCH monitoring during the on duration 510-a). The DCI 505-a may schedule a downlink signal (e.g., a PDSCH 525-a) that is to occur after the on duration 510-a.

The UE may continue PDCCH monitoring during the inactivity timer 515 (e.g., may extend a DRX active time) based on having received the DCI 505-a during the on duration 510-a. The UE may receive the DCI 505-a during the inactivity timer 515. The DCI 505-a may schedule the PDSCH 525-b. In such examples, the UE may extend the inactivity timer 515 by extension 520 (e.g., may extend the inactivity timer 515 to the end of a PDSCH 525 associated with the DCI 505 received during the inactivity timer 515.

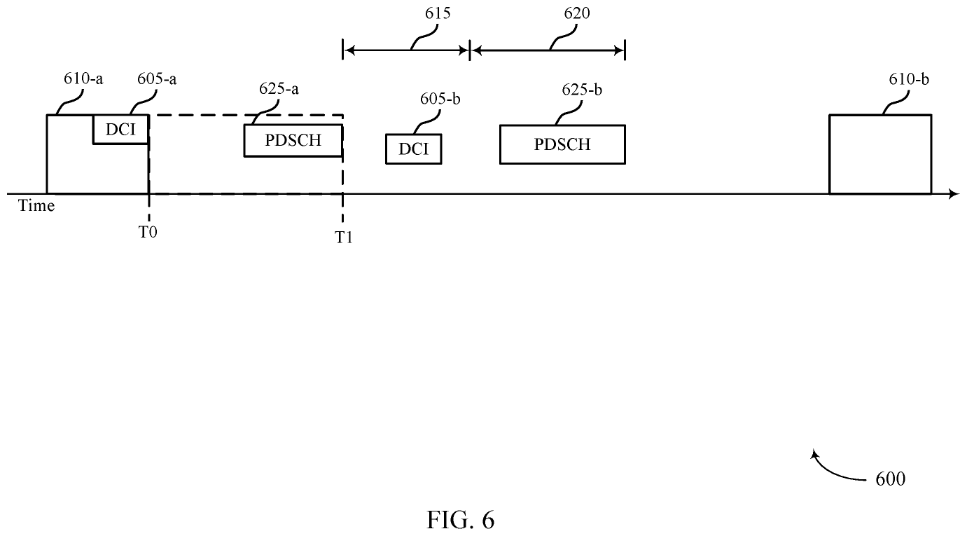

FIG. 6 illustrates an example of a timeline 600 that supports adaptable DRX cycles in accordance with one or more aspects of the present disclosure. Timeline 600 may implement, or be implemented by, aspects of wireless communications system 100, timeline 200, timeline 300, timeline 400, and timeline 500. For example, a network entity (e.g., a network entity 105) and a UE (e.g., a UE 115), which may be examples of corresponding devices described with reference to FIGS. 1-5, may communicate according to timeline 600. The UE may communicate with the network entity according to a DRX cycle, where the UE is configured with one or more on durations 610 (e.g., on duration 610-a and on duration 610-b), and one or more WUSs (e.g., prior to each respective on duration 610). The UE may also be configured with an inactivity timer 615. A first on duration 610-a may be scheduled to terminate at time TO.

The UE may receive a DCI 605-a during the on duration 610-a. The DCI 605-a may schedule a PDSCH 625-a. The scheduled PDSCH 625-a may occur after time TO (e.g., after the on duration 610-a. In such examples, the UE may extend the monitoring time period (e.g., the DRX active time duration) by extending the on duration 610-a to last until fully receiving the PDSCH 625-a associated with the last received PDCCH (e.g., the DCI 605-a during the un-extended on duration 610-a). Extension of the on duration 610-a may include extension of a PDCCH monitoring period (e.g., the UE may continue to perform PDCCH monitoring during the on duration 610-a. The UE may extend the on duration 610-a to an end (e.g., a last time interval such as a last slot or a last symbol) of the PDSCH 625-a (e.g., may extend the on duration 610-a to time T1).

Upon expiration of the extended on duration 610-a (e.g., at time T1), the UE may apply (e.g., initiate) the inactivity timer 615 (e.g., or a modified version of the inactivity timer). In some examples, the UE may initiate the inactivity timer 615 if a PDCCH has been received during the on duration 610-a (e.g., the DCI 605-a, or another DCI message occurring during the extension of the on duration 610-a). The inactivity timer 615 may not be applied until after a last PDSCH (e.g., the PDSCH 625-a). In some examples, the UE may further extend the monitoring time period (e.g., the DRX active time) if another DCI message (e.g., the DCI 605-b) is received during the inactivity timer 615. For instance, if the UE receives the DCI 605-b during the inactivity timer 615, the UE may further extend the monitoring time period by adding extension 620 to the inactivity timer 615. Extension 620 may extend the monitoring time period until the end of the PDSCH 625-b scheduled by the DCI 605-b. Such additional extension (e.g., or refraining from applying additional extensions) of the monitoring time period may be configured or preconfigured (e.g., indicated by the network entity via control signaling), or may be indicated in one or more standards documents. In some examples, the UE may determine whether to initially extend the on duration 610-a, or to apply the extension 620 to the inactivity timer 615, or to initiate the inactivity timer 615 after time T1, or any combination thereof, based on a power saving mode, one or more energy parameters at the UE satisfying an energy threshold (e.g., battery power, energy expenditure, charging rate, discharging rate), among other examples. In some examples, the network entity may provide some instructions (e.g., energy thresholds, rules under which to extend the monitoring time period, among other examples) via L1, L2, or L3 indications. In some examples the UE may extend the monitoring period (e.g., as described with reference to FIGS. 4-6) according to an agreement between devices (e.g., the network entity and the UE). The UE and the network entity may then map one or more conditions or rules to a current scenario, and may perform monitoring time period extensions according to the agreement and the current scenario.

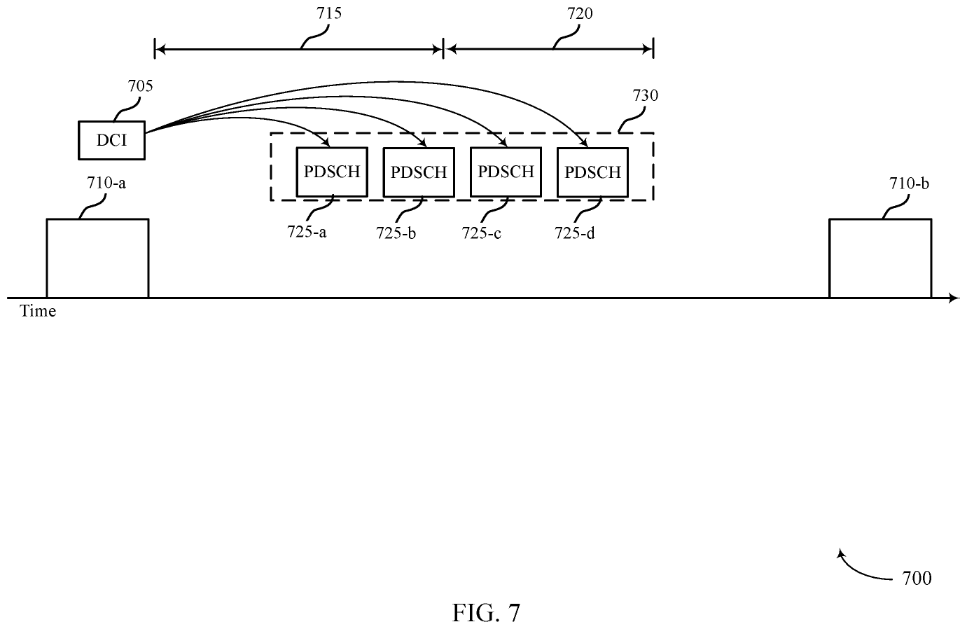

FIG. 7 illustrates an example of a timeline 700 that supports adaptable DRX cycles in accordance with one or more aspects of the present disclosure. Timeline 700 may implement, or be implemented by, aspects of wireless communications system 100, timeline 200, timeline 300, timeline 400, timeline 500, and timeline 600. For example, a network entity (e.g., a network entity 105) and a UE (e.g., a UE 115), which may be examples of corresponding devices described with reference to FIGS. 1-6, may communicate according to timeline 700. The UE may communicate with the network entity according to a DRX cycle, where the UE is configured with one or more on durations 710 (e.g., on duration 710-a and on duration 710-b), and one or more WUSs (e.g., prior to each respective on duration 710). The UE may also be configured with an inactivity timer 715.

The UE may receive a DCI 705 during the on duration 710-a. The DCI 705 may schedule a burst of arrivals (e.g., an ADU 730 including PDSCH 725-a, PDSCH 725-b. PDSCH 725-c, and PDSCH 725-d). ADUs 730 may include multiple uplink transmissions (e.g., multiple PUSCHs), multiple downlink transmissions (PDSCHs 725), or both. ADUs may transfer an XR video frame. PDSCHs 725 may be configured on a same CG (e.g., semi-persistent scheduling (SPS) occasion. The PDSCHs 725 of an ADU 730 may be scheduled by the same DCI (e.g., the DCI 705).

The UE may initiate the inactivity timer 715 upon expiration of the on duration 710-a (e.g., based on having received the DCI 705 during the on duration). However, in some examples (e.g., for XR scenarios when the PDCCH indicates a burst of arrivals such as the ADU 730), the UE may stay awake to receive the entire ADU. If the UE goes to sleep upon expiration of an un-extended inactivity timer 715, the UE may fail to receive some of the ADU (e.g., the PDSCH 725-c and the PDSCH 725-d). If such occurs, the UE may not receive one or more TBs of the ADU 730. Instead, the UE may the UE may modify the inactivity timer 715 and wait to go to sleep until it has received the entire ADU 730. For example, the UE may set the inactivity timer to a non-zero value or a zero value, and may extend the monitoring time period until the end of the final PDSCH 725-d of the ADU 730 (e.g., the UE may extend the inactivity timer by the extension 720, or may ignore the inactivity timer and stay away until the end of the ADU 730).

In some examples, the UE may start the inactivity timer after the last PDSCH 725-d of the ADU 730 (e.g., instead of starting the inactivity timer from reception of the PDCCH carrying the DCI 705). In such examples, the UE may start the inactivity timer after receiving the PDSCH 725-d. The UE may adjust the time (e.g., of the PDSCH occasion) offset, which may be indicated via L1, L2, or L3 signaling. L1 signaling may be the scheduling DCI 705, or another scheduling or non-scheduling DCI or WUS, indicating when the UE is to initiate the inactivity timer.

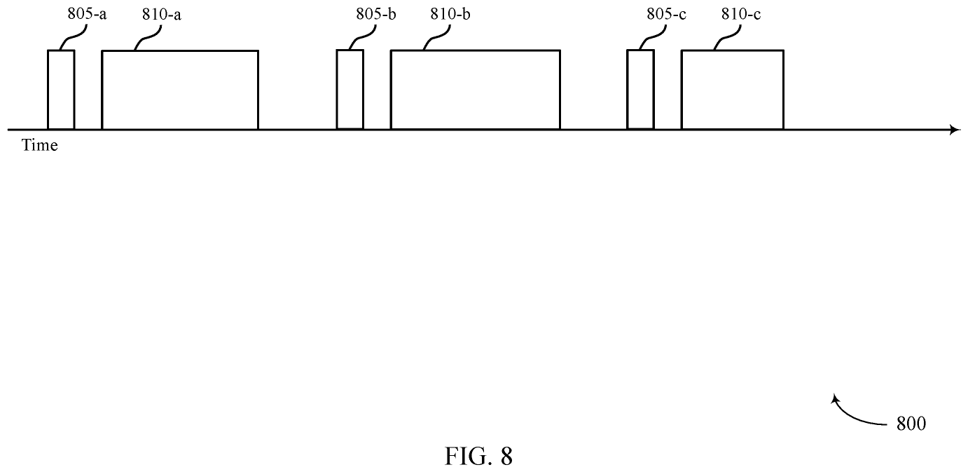

FIG. 8 illustrates an example of a timeline 800 that supports adaptable DRX cycles in accordance with one or more aspects of the present disclosure. Timeline 800 may implement, or be implemented by, aspects of wireless communications system 100, timeline 200, timeline 300, timeline 400, timeline 500, timeline 600, and timeline 700. For example, a network entity (e.g., a network entity 105) and a UE (e.g., a UE 115), which may be examples of corresponding devices described with reference to FIGS. 1-7, may communicate according to timeline 800. The UE may communicate with the network entity according to a DRX cycle, where the UE is configured with one or more on durations 810 (e.g., on duration 810-a, on duration 810-b, and on duration 810-c), and one or more WUSs (e.g., WUS 805-a, WUS 805-b, and WUS 805-c). The UE may also be configured with an inactivity timer.

The UE may apply different DRX configurations based on a WUS occasion during which a WUS 805 is received. For example, the UE may apply a same (e.g., a default or previously configured) DRX configuration if a received WUS 805 is received on a same WUS occasion, even if an adjustment to the DRX cycle (e.g., as described in greater detail with reference to FIG. 3) was received during a previous (e.g., different) WUS 805.

In some examples, the DRX configurations may be based on a WUS occasion. For instance, the UE may be configured with an initial (e.g., default) DRX configuration, including DRX parameters such as a duration of the on durations 810, a duration of an inactivity timer, one or more rules for extending monitoring time periods). The first DRX configuration may be associated with a WUS occasion 2. The UE may receive a WUS 805-a during a WUS occasion 1. The WUS 805-a may indicate an updated or changed DRX configuration. THE DRX adjustment or configuration may indicate a different set of DRX parameters (e.g., a longer on duration 810) or extended monitoring period. Based on having received the WUS 805-a, the UE may perform wireless communications (e.g., during the associated on duration 810-a) according to the updated DRX configuration. Similarly, if the UE receives the WUS 805-b during the WUS occasion 1, the UE may determine to use the updated DRX configuration for the on duration 810-b. If the UE receives the WUS 805-c via a WUS occasion 2, then the UE may revert to the default or original DRX occasion for the on duration 810-c.

In some examples, the network may indicate an updated DRX configuration, and the network may also indicate a time duration for which the updated DRX configuration applies. For instance, the WUS 805-a may indicate an updated DRX configuration, and my further indicate that the updated DRX configuration applies for an amount of time (e.g., until expiration of the on duration 810-b), or a number of DRX cycles (e.g., two DRX cycles), among other examples. In such cases, the UE may communicate during the on duration 810-a and the on duration 810-b according to the updated DRX cycles, and may revert to the previous or default DRX configuration for the on duration 810-c.

Thus, as described with reference to FIG. 8, UEs may apply or use a certain DRX configuration including active times, timer starting from certain time offsets, for all or for one or more upcoming DRX occasions, if the WUS is received via a same WUS occasion (e.g., an original WUS occasion via which the default or original DRX occasion was received). If the WUS occasion changes, this may mean that the UE is to use another or a default or old configuration, not the new one. In other words, the DRX new configuration may be used for all occasions as long as the UE receives the WUS on a same monitoring occasion, unless new configurations are received, or unless a WUS is sent on another WUS occasion. In some examples, such concepts may be applied during a time window (e.g., a number of DRX cycles, or a periodicity), after which, the techniques described with reference to FIG. 8 may not be applied. Such an applicability size may be associated with particular WUS occasions (e.g., the WUS occasion in which the WUS 805 is received may indicate how long a configuration lasts).

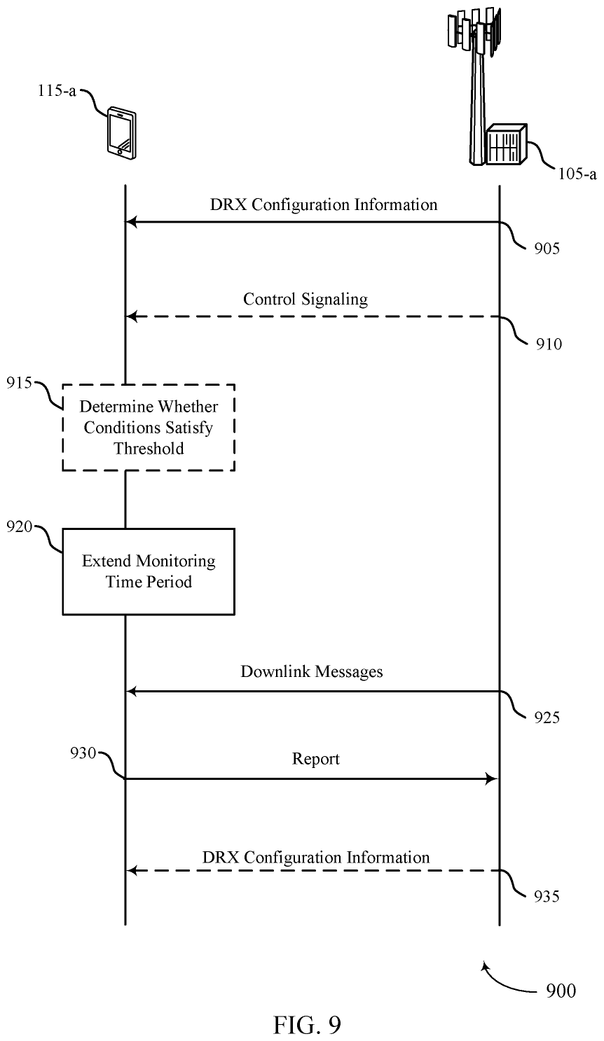

FIG. 9 shows a process flow 900 that supports adaptable DRX cycles in accordance with one or more aspects of the present disclosure. The process flow 900 may include a UE 115-a and a network entity 105-a, which may be examples of corresponding devices described with reference to FIGS. 1-8.

At 905, the network entity 105-a may transmit, and the UE 115-a may receive, control signaling, which may include DRX configuration information. The DRX configuration information may include, for example, an indication of a first on duration, an inactivity timer, one or more rules or conditions, one or more energy thresholds, traffic thresholds, or any combination thereof.

At 920, the UE 115-a may extend, based on a detected trigger, a monitoring time period associated with the first on duration. Extending the monitoring time period may include extending the inactivity timer, extending the on duration of the DRX cycle, or a combination thereof.

At 925, the UE 115-a may monitor for and receive one or more downlink messages during the extended monitoring time period (e.g., after the initially configured on duration based on extending the on duration, or extending the inactivity timer, or both).

In some examples, the trigger may be a control message (e.g., control signaling received at 910). For instance, the UE 115-a may receive a first WUS associated with the first on duration. The first WUS may indicate a time interval by which to extend the on duration or the inactivity timer. Such an indication may also be received via a DCI message (e.g., a scheduling DCI or a non-scheduling DCI), or higher layer signaling (e.g., a MAC-CE or RRC message). In such examples, the UE 115-a may extend the monitoring time period by the indicated time interval at 920.

In some examples, the UE 115-a may receive a control message at 910, which may be a WUS or a DCI message. THE DCI message indicate a power threshold (e.g., an energy threshold). Such power thresholds may similarly be indicated via MAC-CE signaling or RRC signaling. the UE 115-a may detect a trigger when a current measured energy or power parameter satisfies the power threshold. The detected trigger may be a determination that one or more parameters satisfy the power threshold. The one or more parameters may include a UE charging rate, a UE discharging rate, a UE energy level, a power headroom, or a combination thereof. In some examples, at 915, the UE 115-a may measure the one or more parameters prior to expiration of the inactivity timer, prior to an offset from an end of a previous on duration of the discontinuous reception cycle, prior to an offset from a beginning of the first on duration, based on a current energy state calculation, or any combination thereof.

In some examples, the control signaling received at 910 (e.g., or previous control signaling) may indicate a communication state associated with extending the monitoring time period (e.g., indicating one or more rules or procedures under which the UE 115-a is permitted to or instructed to extend the monitoring time period). the UE 115-a may then extend the monitoring time period according to the indication of the communication mode.

In some examples, the control signaling received at 910 may indicate a threshold ratio between a quantity of downlink messages and a quantity of time intervals. In such examples, at 915, the UE 115-a may detect the trigger (e.g., may determine whether conditions satisfy the threshold) by determining that a quantity downlink messages during the first on duration satisfies the threshold ratio. Extending the monitoring time period at 920 may be based at least in part on receiving the plurality of downlink messages.

In some examples (e.g., as described with reference to FIG. 3), the UE 115-a may autonomously determine to extend the monitoring time period, where the trigger includes determining that one or more rules or conditions are satisfied. For example, the UE 115-a may receive DCI message (e.g., at 910) scheduling a downlink message after the first on duration. In such examples (e.g., as described in greater detail with reference to FIGS. 4-5), the UE 115-a may select the greater of a first time period associated with the inactivity timer, or a second time period between reception of the DCI message and a last symbol of the scheduled at least one downlink message, and extending the monitoring time period includes extending the monitoring time period according to the selecting. In some cases, the UE 115-a may receive, based at least in part on extending the monitoring time period, a second DCI message scheduling an additional message including an uplink message or a downlink message after the first on duration. The UE 115-a may select the greater of a time interval associated with the inactivity timer, or a third time period between reception of the second DCI message and a last symbol of the additional message. The UE 115-a may further extend the monitoring time period according to the selected time interval or the third time period, and may receive additional downlink messages according to the further extended monitoring time period. In some cases, the UE 115-a may extend the monitoring time period first by extending the on duration, and subsequently by extending the inactivity timer (e.g., as described with reference to FIG. 6).

In some cases, the trigger may include receiving the DCI message at 910 scheduling an ADU, as described in greater detail with reference to FIG. 7. In such examples, the UE 115-a may extend the monitoring time period to a last symbol of a last downlink transmission of the multiple transmissions of the ADU.

In some examples, the UE 115-a may report one or more statistics or parameters associated with channel traffic, energy consumption at the UE 115-a, or a combination thereof at 930. At 935, the UE 115-a may receive control signaling indicating an updated time interval for subsequent on durations of the DRX cycle (e.g., updated DRX configurations, as described in greater detail with reference to FIG. 3 and FIG. 8). The UE 115-a may monitor for additional downlink signaling according to the updated DRX cycle.

As described herein (e.g., at 920), the network entity 105-a may implement any of the techniques described herein to determine that the monitoring time period at the UE has been extended, and that the UE 115-a will therefore be able to receive downlink signaling scheduled for and transmitted time periods otherwise outside of an on duration.

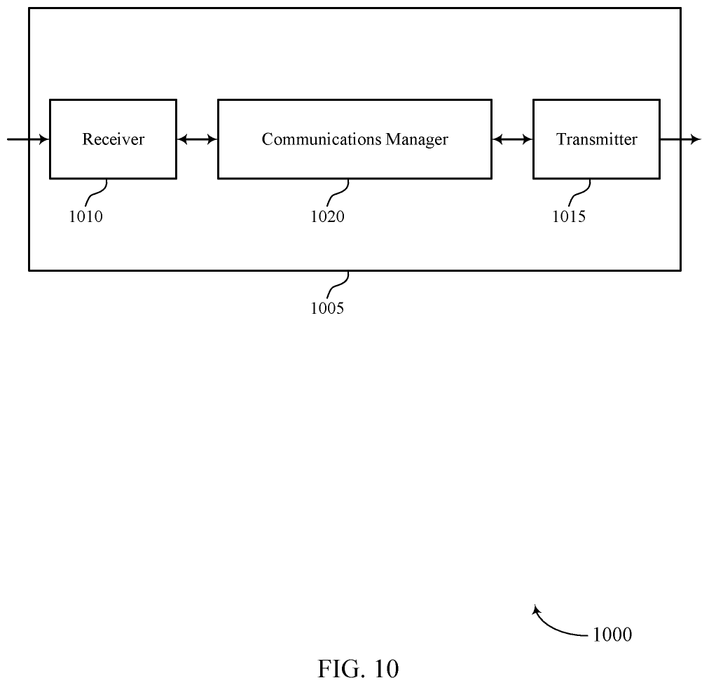

FIG. 10 shows a block diagram 1000 of a device 1005 that supports adaptable DRX cycles in accordance with one or more aspects of the present disclosure. The device 1005 may be an example of aspects of a UE 115 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for receiving information such as packets, user data, control information, or any combination thereof associated with various information channels (e.g., control channels, data channels, information channels related to adaptable DRX cycles). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to adaptable DRX cycles). In some examples, the transmitter 1015 may be co-located with a receiver 1010 in a transceiver module. The transmitter 1015 may utilize a single antenna or a set of multiple antennas.

The communications manager 1020, the receiver 1010, the transmitter 1015, or various combinations thereof or various components thereof may be examples of means for performing various aspects of adaptable DRX cycles as described herein. For example, the communications manager 1020, the receiver 1010, the transmitter 1015, or various combinations or components thereof may support a method for performing one or more of the functions described herein.

In some examples, the communications manager 1020, the receiver 1010, the transmitter 1015, or various combinations or components thereof may be implemented in hardware (e.g., in communications management circuitry). The hardware may include a processor, a digital signal processor (DSP), a central processing unit (CPU), a graphics processing unit (GPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1020, the receiver 1010, the transmitter 1015, or various combinations or components thereof may be implemented in code (e.g., as communications management software) executed by a processor. If implemented in code executed by a processor, the functions of the communications manager 1020, the receiver 1010, the transmitter 1015, or various combinations or components thereof may be performed by a general-purpose processor, a DSP, a CPU, a GPU an ASIC, an FPGA, a microcontroller, or any combination of these or other programmable logic devices (e.g., configured as or otherwise supporting a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications at a UE in accordance with examples as disclosed herein. For example, the communications manager 1020 may be configured as or otherwise support a means for receiving control signaling indicating a first on duration of a discontinuous reception cycle. The communications manager 1020 may be configured as or otherwise support a means for extending, based on a detected trigger, a monitoring time period associated with the first on duration, the extending including modifying the first on duration, modifying an inactivity timer associated with the first on duration, or a combination thereof. The communications manager 1020 may be configured as or otherwise support a means for receiving one or more downlink messages during the extended monitoring time period.

By including or configuring the communications manager 1020 in accordance with examples as described herein, the device 1005 (e.g., a processor controlling or otherwise coupled with the receiver 1010, the transmitter 1015, the communications manager 1020, or a combination thereof) may support techniques for extending a monitoring time period resulting in increased power savings, more efficient use of available system resources, support for bursty communications such as XR communications, more reliable wireless communications, improved battery life, and improved user experience.

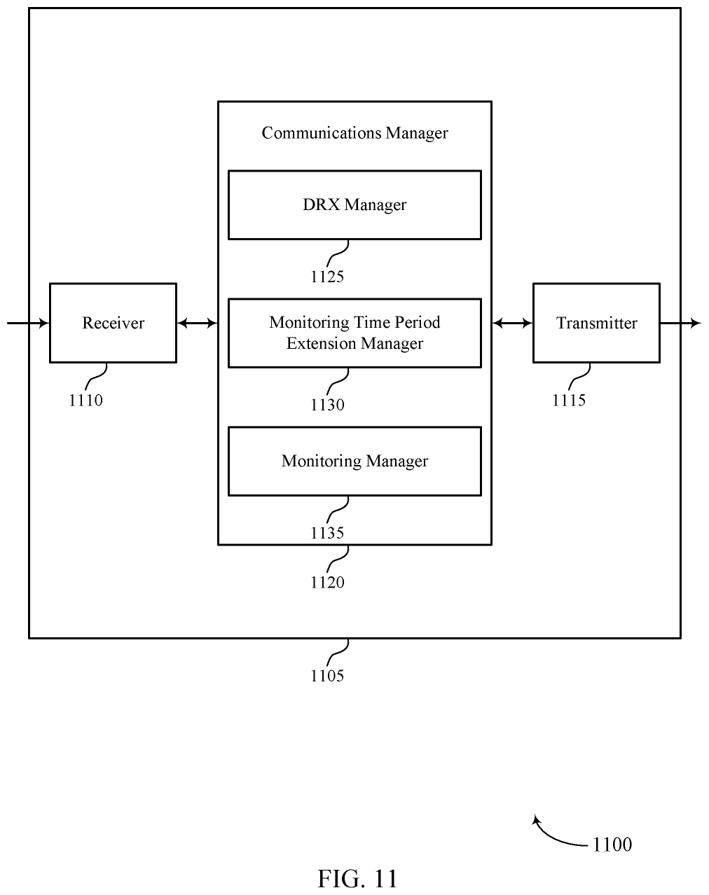

FIG. 11 shows a block diagram 1100 of a device 1105 that supports adaptable DRX cycles in accordance with one or more aspects of the present disclosure. The device 1105 may be an example of aspects of a device 1005 or a UE 115 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for receiving information such as packets, user data, control information, or any combination thereof associated with various information channels (e.g., control channels, data channels, information channels related to adaptable DRX cycles). Information may be passed on to other components of the device 1105. The receiver 1110 may utilize a single antenna or a set of multiple antennas.

The transmitter 1115 may provide a means for transmitting signals generated by other components of the device 1105. For example, the transmitter 1115 may transmit information such as packets, user data, control information, or any combination thereof associated with various information channels (e.g., control channels, data channels, information channels related to adaptable DRX cycles). In some examples, the transmitter 1115 may be co-located with a receiver 1110 in a transceiver module. The transmitter 1115 may utilize a single antenna or a set of multiple antennas.

The device 1105, or various components thereof, may be an example of means for performing various aspects of adaptable DRX cycles as described herein. For example, the communications manager 1120 may include a DRX manager 1125, a monitoring time period extension manager 1130, a monitoring manager 1135, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications at a UE in accordance with examples as disclosed herein. The DRX manager 1125 may be configured as or otherwise support a means for receiving control signaling indicating a first on duration of a discontinuous reception cycle. The monitoring time period extension manager 1130 may be configured as or otherwise support a means for extending, based on a detected trigger, a monitoring time period associated with the first on duration, the extending including modifying the first on duration, modifying an inactivity timer associated with the first on duration, or a combination thereof. The monitoring manager 1135 may be configured as or otherwise support a means for receiving one or more downlink messages during the extended monitoring time period.

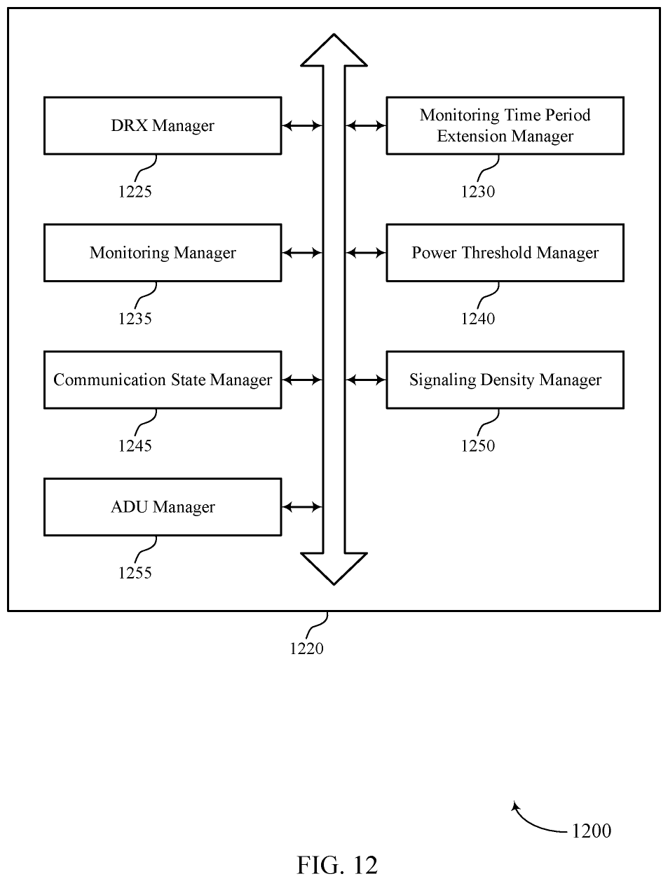

FIG. 12 shows a block diagram 1200 of a communications manager 1220 that supports adaptable DRX cycles in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of adaptable DRX cycles as described herein. For example, the communications manager 1220 may include a DRX manager 1225, a monitoring time period extension manager 1230, a monitoring manager 1235, a power threshold manager 1240, a communication state manager 1245, a signaling density manager 1250, an ADU manager 1255, or any combination thereof. Each of these components may communicate, directly or indirectly, with one another (e.g., via one or more buses).

The communications manager 1220 may support wireless communications at a UE in accordance with examples as disclosed herein. The DRX manager 1225 may be configured as or otherwise support a means for receiving control signaling indicating a first on duration of a discontinuous reception cycle. The monitoring time period extension manager 1230 may be configured as or otherwise support a means for extending, based on a detected trigger, a monitoring time period associated with the first on duration, the extending including modifying the first on duration, modifying an inactivity timer associated with the first on duration, or a combination thereof. The monitoring manager 1235 may be configured as or otherwise support a means for receiving one or more downlink messages during the extended monitoring time period.

In some examples, the monitoring time period extension manager 1230 may be configured as or otherwise support a means for receiving a first wakeup signal including the detected trigger, the first wakeup signal associated with the first on duration and including an indication of a time interval where extending the monitoring time period includes extending the monitoring time period according to the indication of the time interval.

In some examples, the power threshold manager 1240 may be configured as or otherwise support a means for receiving a control message, the control message including a first wakeup signal associated with the first on duration or a DCI message, and the control message further including an indication of a power threshold, where the detected trigger includes a determination that one or more parameters satisfy the power threshold, where the one or more parameters include a UE charging rate, a UE discharging rate, a UE energy level, a power headroom, or a combination thereof.

In some examples, the power threshold manager 1240 may be configured as or otherwise support a means for measuring the one or more parameters prior to expiration of the inactivity timer, prior to an offset from an end of a previous on duration of the discontinuous reception cycle, prior to an offset from a beginning of the first on duration, based on a current energy state calculation, or any combination thereof.

In some examples, the communication state manager 1245 may be configured as or otherwise support a means for receiving control signaling indicating a communication state, the control signaling including the detected trigger, where extending the monitoring time period is based on the communication state.

In some examples, the monitoring time period extension manager 1230 may be configured as or otherwise support a means for receiving, during the first on duration, a DCI message including an indication of a time interval, the indication of the time interval including the detected trigger, where extending the monitoring time period includes extending the monitoring time period according to the indication of the time interval.

In some examples, the signaling density manager 1250 may be configured as or otherwise support a means for receiving control signaling indicating a threshold ratio between a quantity of downlink messages and a quantity of time intervals. In some examples, the signaling density manager 1250 may be configured as or otherwise support a means for determining that a set of multiple downlink messages during the first on duration satisfies the threshold ratio, the determining including the detected trigger, where extending the monitoring time period is based on receiving the set of multiple downlink messages.

In some examples, the monitoring time period extension manager 1230 may be configured as or otherwise support a means for receiving, during the first on duration, a DCI message scheduling at least one message including an uplink message or a downlink message after the first on duration. In some examples, the monitoring time period extension manager 1230 may be configured as or otherwise support a means for selecting the greater of a first time period associated with the inactivity timer, or a second time period between reception of the DCI message and a last symbol of the scheduled at least one message, where extending the monitoring time period includes extending the monitoring time period according to the selecting.

In some examples, the monitoring time period extension manager 1230 may be configured as or otherwise support a means for receiving, based on extending the monitoring time period, a second DCI message scheduling an additional message including an uplink message or a downlink message after the first on duration. In some examples, the monitoring time period extension manager 1230 may be configured as or otherwise support a means for selecting the greater of a time interval associated with the inactivity timer, or a third time period between reception of the second DCI message and a last symbol of the additional message. In some examples, the monitoring time period extension manager 1230 may be configured as or otherwise support a means for further extending the monitoring time period according to the selected time interval or the third time period. In some examples, the monitoring time period extension manager 1230 may be configured as or otherwise support a means for communicating the additional message according to the further extended monitoring time period.

In some examples, the monitoring time period extension manager 1230 may be configured as or otherwise support a means for extending the monitoring time period according to the selecting includes extending the on duration. In some examples, the monitoring time period extension manager 1230 may be configured as or otherwise support a means for further extending the monitoring time period according to the time interval associated with the inactivity timer or the third time period includes extending the inactivity timer.

In some examples, the ADU manager 1255 may be configured as or otherwise support a means for receiving, during the first on duration, a DCI message scheduling an application data unit including a set of multiple downlink transmissions where extending the monitoring time period includes extending the monitoring time period to a last symbol of a last downlink transmission of the set of multiple transmissions.

In some examples, the DRX manager 1225 may be configured as or otherwise support a means for receiving control signaling indicating an updated time interval for subsequent on durations of the discontinuous reception cycle, an updated time interval for the inactivity timer, or a combination thereof. In some examples, the DRX manager 1225 may be configured as or otherwise support a means for monitoring for downlink signaling according to the updated time interval for the subsequent on durations, the updated time interval for the inactivity timer, or both.

In some examples, the DRX manager 1225 may be configured as or otherwise support a means for reporting one or more parameters associated with energy consumption at the UE, where receiving the control signaling indicating the updated time interval for each on duration, the updated time interval for the inactivity timer, or the combination thereof, is based on reporting the one or more parameters.

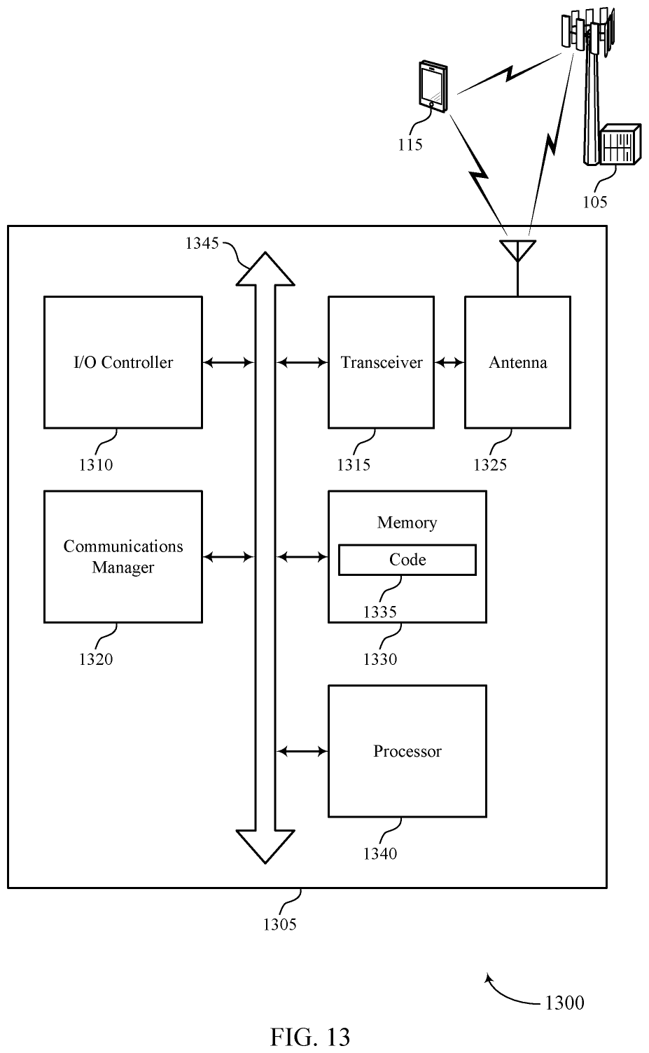

FIG. 13 shows a diagram of a system 1300 including a device 1305 that supports adaptable DRX cycles in accordance with one or more aspects of the present disclosure. The device 1305 may be an example of or include the components of a device 1005, a device 1105, or a UE 115 as described herein. The device 1305 may communicate (e.g., wirelessly) with one or more network entities 105, one or more UEs 115, or any combination thereof. The device 1305 may include components for bi-directional voice and data communications including components for transmitting and receiving communications, such as a communications manager 1320, an input/output (I/O) controller 1310, a transceiver 1315, an antenna 1325, a memory 1330, code 1335, and a processor 1340. These components may be in electronic communication or otherwise coupled (e.g., operatively, communicatively, functionally, electronically, electrically) via one or more buses (e.g., a bus 1345).

The I/O controller 1310 may manage input and output signals for the device 1305. The I/O controller 1310 may also manage peripherals not integrated into the device 1305. In some cases, the I/O controller 1310 may represent a physical connection or port to an external peripheral. In some cases, the I/O controller 1310 may utilize an operating system such as iOS®, ANDROID®, MS-DOS®, MS-WINDOWS®, OS/2®, UNIX®, LINUX®, or another known operating system. Additionally or alternatively, the I/O controller 1310 may represent or interact with a modem, a keyboard, a mouse, a touchscreen, or a similar device. In some cases, the I/O controller 1310 may be implemented as part of a processor, such as the processor 1340. In some cases, a user may interact with the device 1305 via the I/O controller 1310 or via hardware components controlled by the I/O controller 1310.

In some cases, the device 1305 may include a single antenna 1325. However, in some other cases, the device 1305 may have more than one antenna 1325, which may be capable of concurrently transmitting or receiving multiple wireless transmissions. The transceiver 1315 may communicate bi-directionally, via the one or more antennas 1325, wired, or wireless links as described herein. For example, the transceiver 1315 may represent a wireless transceiver and may communicate bi-directionally with another wireless transceiver. The transceiver 1315 may also include a modem to modulate the packets, to provide the modulated packets to one or more antennas 1325 for transmission, and to demodulate packets received from the one or more antennas 1325. The transceiver 1315, or the transceiver 1315 and one or more antennas 1325, may be an example of a transmitter 1015, a transmitter 1115, a receiver 1010, a receiver 1110, or any combination thereof or component thereof, as described herein.

The memory 1330 may include random access memory (RAM) and read-only memory (ROM). The memory 1330 may store computer-readable, computer-executable code 1335 including instructions that, when executed by the processor 1340, cause the device 1305 to perform various functions described herein. The code 1335 may be stored in a non-transitory computer-readable medium such as system memory or another type of memory. In some cases, the code 1335 may not be directly executable by the processor 1340 but may cause a computer (e.g., when compiled and executed) to perform functions described herein. In some cases, the memory 1330 may contain, among other things, a basic I/O system (BIOS) which may control basic hardware or software operation such as the interaction with peripheral components or devices.

The processor 1340 may include an intelligent hardware device (e.g., a general-purpose processor, a DSP, a CPU, a GPU a microcontroller, an ASIC, an FPGA, a programmable logic device, a discrete gate or transistor logic component, a discrete hardware component, or any combination thereof). In some cases, the processor 1340 may be configured to operate a memory array using a memory controller. In some other cases, a memory controller may be integrated into the processor 1340. The processor 1340 may be configured to execute computer-readable instructions stored in a memory (e.g., the memory 1330) to cause the device 1305 to perform various functions (e.g., functions or tasks supporting adaptable DRX cycles). For example, the device 1305 or a component of the device 1305 may include a processor 1340 and memory 1330 coupled with or to the processor 1340, the processor 1340 and memory 1330 configured to perform various functions described herein.

The communications manager 1320 may support wireless communications at a UE in accordance with examples as disclosed herein. For example, the communications manager 1320 may be configured as or otherwise support a means for receiving control signaling indicating a first on duration of a discontinuous reception cycle. The communications manager 1320 may be configured as or otherwise support a means for extending, based on a detected trigger, a monitoring time period associated with the first on duration, the extending including modifying the first on duration, modifying an inactivity timer associated with the first on duration, or a combination thereof. The communications manager 1320 may be configured as or otherwise support a means for receiving one or more downlink messages during the extended monitoring time period.

By including or configuring the communications manager 1320 in accordance with examples as described herein, the device 1305 may support techniques for extending a monitoring time period resulting in increased power savings, more efficient use of available system resources, support for bursty communications such as XR communications, more reliable wireless communications, improved battery life, and improved user experience.

In some examples, the communications manager 1320 may be configured to perform various operations (e.g., receiving, monitoring, transmitting) using or otherwise in cooperation with the transceiver 1315, the one or more antennas 1325, or any combination thereof. Although the communications manager 1320 is illustrated as a separate component, in some examples, one or more functions described with reference to the communications manager 1320 may be supported by or performed by the processor 1340, the memory 1330, the code 1335, or any combination thereof. For example, the code 1335 may include instructions executable by the processor 1340 to cause the device 1305 to perform various aspects of adaptable DRX cycles as described herein, or the processor 1340 and the memory 1330 may be otherwise configured to perform or support such operations.

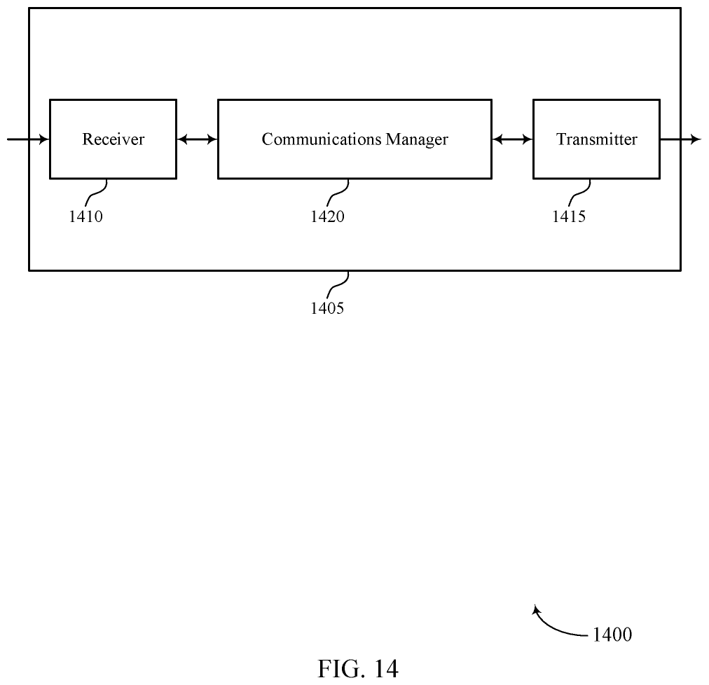

FIG. 14 shows a block diagram 1400 of a device 1405 that supports adaptable DRX cycles in accordance with one or more aspects of the present disclosure. The device 1405 may be an example of aspects of a network entity 105 as described herein. The device 1405 may include a receiver 1410, a transmitter 1415, and a communications manager 1420. The device 1405 may also include a processor. Each of these components may be in communication with one another (e.g., via one or more buses).

The receiver 1410 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1405. In some examples, the receiver 1410 may support obtaining information by receiving signals via one or more antennas. Additionally, or alternatively, the receiver 1410 may support obtaining information by receiving signals via one or more wired (e.g., electrical, fiber optic) interfaces, wireless interfaces, or any combination thereof.

The transmitter 1415 may provide a means for outputting (e.g., transmitting, providing, conveying, sending) information generated by other components of the device 1405. For example, the transmitter 1415 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1415 may support outputting information by transmitting signals via one or more antennas. Additionally, or alternatively, the transmitter 1415 may support outputting information by transmitting signals via one or more wired (e.g., electrical, fiber optic) interfaces, wireless interfaces, or any combination thereof. In some examples, the transmitter 1415 and the receiver 1410 may be co-located in a transceiver, which may include or be coupled with a modem.

The communications manager 1420, the receiver 1410, the transmitter 1415, or various combinations thereof or various components thereof may be examples of means for performing various aspects of adaptable DRX cycles as described herein. For example, the communications manager 1420, the receiver 1410, the transmitter 1415, or various combinations or components thereof may support a method for performing one or more of the functions described herein.

In some examples, the communications manager 1420, the receiver 1410, the transmitter 1415, or various combinations or components thereof may be implemented in hardware (e.g., in communications management circuitry). The hardware may include a processor, a DSP, a CPU, a GPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1420, the receiver 1410, the transmitter 1415, or various combinations or components thereof may be implemented in code (e.g., as communications management software) executed by a processor. If implemented in code executed by a processor, the functions of the communications manager 1420, the receiver 1410, the transmitter 1415, or various combinations or components thereof may be performed by a general-purpose processor, a DSP, a CPU, a GPU, an ASIC, an FPGA, a microcontroller, or any combination of these or other programmable logic devices (e.g., configured as or otherwise supporting a means for performing the functions described in the present disclosure).

In some examples, the communications manager 1420 may be configured to perform various operations (e.g., receiving, obtaining, monitoring, outputting, transmitting) using or otherwise in cooperation with the receiver 1410, the transmitter 1415, or both. For example, the communications manager 1420 may receive information from the receiver 1410, send information to the transmitter 1415, or be integrated in combination with the receiver 1410, the transmitter 1415, or both to obtain information, output information, or perform various other operations as described herein.

The communications manager 1420 may support wireless communications at a network entity in accordance with examples as disclosed herein. For example, the communications manager 1420 may be configured as or otherwise support a means for transmitting, to a UE, control signaling indicating a first on duration of a discontinuous reception cycle. The communications manager 1420 may be configured as or otherwise support a means for transmitting, to the UE, one or more downlink messages during an extended monitoring time period associated with a detected trigger, the extended monitoring time period including a modified on duration, a modified inactivity timer for the UE, or a combination thereof.

By including or configuring the communications manager 1420 in accordance with examples as described herein, the device 1405 (e.g., a processor controlling or otherwise coupled with the receiver 1410, the transmitter 1415, the communications manager 1420, or a combination thereof) may support techniques for extending a monitoring time period resulting in increased power savings, more efficient use of available system resources, support for bursty communications such as XR communications, more reliable wireless communications, improved battery life, and improved user experience.

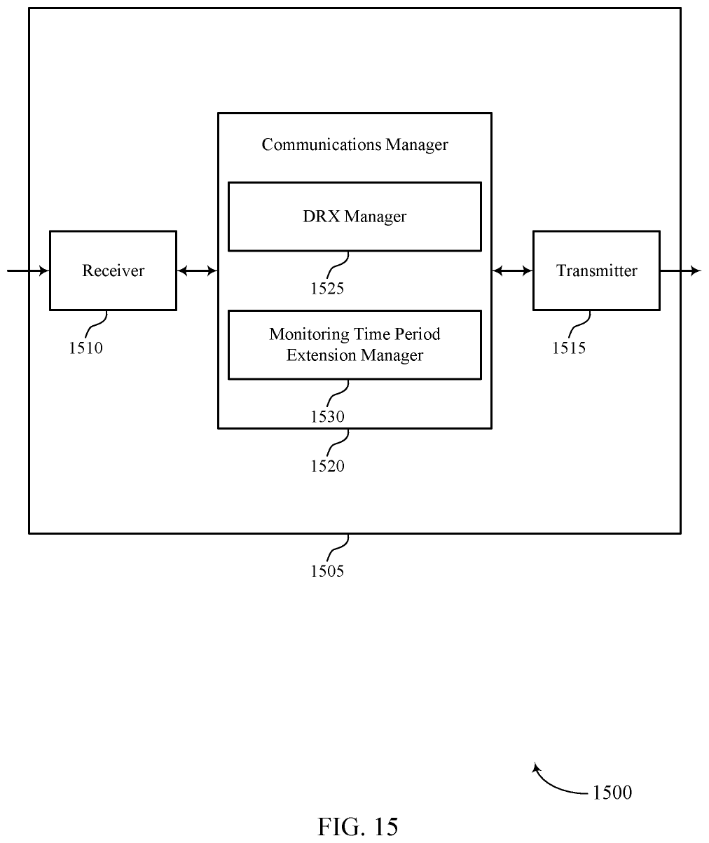

FIG. 15 shows a block diagram 1500 of a device 1505 that supports adaptable DRX cycles in accordance with one or more aspects of the present disclosure. The device 1505 may be an example of aspects of a device 1405 or a network entity 105 as described herein. The device 1505 may include a receiver 1510, a transmitter 1515, and a communications manager 1520. The device 1505 may also include a processor. Each of these components may be in communication with one another (e.g., via one or more buses).

The receiver 1510 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1505. In some examples, the receiver 1510 may support obtaining information by receiving signals via one or more antennas. Additionally, or alternatively, the receiver 1510 may support obtaining information by receiving signals via one or more wired (e.g., electrical, fiber optic) interfaces, wireless interfaces, or any combination thereof.

The transmitter 1515 may provide a means for outputting (e.g., transmitting, providing, conveying, sending) information generated by other components of the device 1505. For example, the transmitter 1515 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1515 may support outputting information by transmitting signals via one or more antennas. Additionally, or alternatively, the transmitter 1515 may support outputting information by transmitting signals via one or more wired (e.g., electrical, fiber optic) interfaces, wireless interfaces, or any combination thereof. In some examples, the transmitter 1515 and the receiver 1510 may be co-located in a transceiver, which may include or be coupled with a modem.

The device 1505, or various components thereof, may be an example of means for performing various aspects of adaptable DRX cycles as described herein. For example, the communications manager 1520 may include a DRX manager 1525 a monitoring time period extension manager 1530, or any combination thereof. The communications manager 1520 may be an example of aspects of a communications manager 1420 as described herein. In some examples, the communications manager 1520, or various components thereof, may be configured to perform various operations (e.g., receiving, obtaining, monitoring, outputting, transmitting) using or otherwise in cooperation with the receiver 1510, the transmitter 1515, or both. For example, the communications manager 1520 may receive information from the receiver 1510, send information to the transmitter 1515, or be integrated in combination with the receiver 1510, the transmitter 1515, or both to obtain information, output information, or perform various other operations as described herein.

The communications manager 1520 may support wireless communications at a network entity in accordance with examples as disclosed herein. The DRX manager 1525 may be configured as or otherwise support a means for transmitting, to a UE, control signaling indicating a first on duration of a discontinuous reception cycle. The monitoring time period extension manager 1530 may be configured as or otherwise support a means for transmitting, to the UE, one or more downlink messages during an extended monitoring time period associated with a detected trigger, the extended monitoring time period including a modified on duration, a modified inactivity timer for the UE, or a combination thereof.

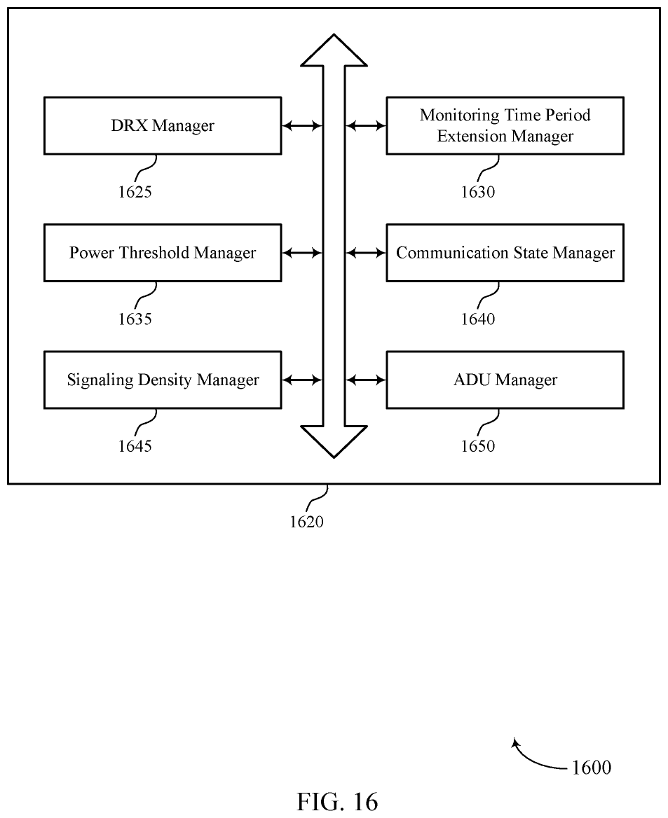

FIG. 16 shows a block diagram 1600 of a communications manager 1620 that supports adaptable DRX cycles in accordance with one or more aspects of the present disclosure. The communications manager 1620 may be an example of aspects of a communications manager 1420, a communications manager 1520, or both, as described herein. The communications manager 1620, or various components thereof, may be an example of means for performing various aspects of adaptable DRX cycles as described herein. For example, the communications manager 1620 may include a DRX manager 1625, a monitoring time period extension manager 1630, a power threshold manager 1635, a communication state manager 1640, a signaling density manager 1645, an ADU manager 1650, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1620 may support wireless communications at a network entity in accordance with examples as disclosed herein. The DRX manager 1625 may be configured as or otherwise support a means for transmitting, to a UE, control signaling indicating a first on duration of a discontinuous reception cycle. The monitoring time period extension manager 1630 may be configured as or otherwise support a means for transmitting, to the UE, one or more downlink messages during an extended monitoring time period associated with a detected trigger, the extended monitoring time period including a modified on duration, a modified inactivity timer for the UE, or a combination thereof.

In some examples, the monitoring time period extension manager 1630 may be configured as or otherwise support a means for transmitting a first wakeup signal including the detected trigger, the first wakeup signal associated with the first on duration and including an indication of a time interval, where the extended monitoring time period is based on the indication of the time interval.

In some examples, the power threshold manager 1635 may be configured as or otherwise support a means for transmitting a control message, the control message including a first wakeup signal associated with the first on duration or a DCI message, the control message further including an indication of a power threshold, where the detected trigger includes a determination that one or more parameters satisfy the power threshold, where the one or more parameters include a UE charging rate, a UE discharging rate, a UE energy level, a power headroom, or a combination thereof.

In some examples, the communication state manager 1640 may be configured as or otherwise support a means for transmitting control signaling indicating a communication state, the control signaling including the detected trigger, where the extended monitoring time period is based on the communication state.

In some examples, the signaling density manager 1645 may be configured as or otherwise support a means for transmitting control signaling indicating a threshold ratio between a quantity of downlink messages and a quantity of time intervals. In some examples, the signaling density manager 1645 may be configured as or otherwise support a means for determining that a set of multiple downlink messages during the first on duration satisfies the threshold ratio, the determining including the detected trigger, where the extended monitoring time period is based on transmitting the set of multiple downlink messages.

In some examples, the monitoring time period extension manager 1630 may be configured as or otherwise support a means for transmitting, during the first on duration, a DCI message scheduling at least one message including an uplink message or a downlink message after the first on duration, where the extended monitoring time period is based on the greater of a first time period associated with the inactivity timer, or a second time period between reception of the DCI message and a last symbol of the scheduled at least one downlink message.

In some examples, the monitoring time period extension manager 1630 may be configured as or otherwise support a means for transmitting, based on the extended monitoring time period, a second DCI message scheduling an additional downlink message including an uplink message or a downlink message after the first on duration, where the extended monitoring time period is based on the greater of a time interval associated with the inactivity timer, or a third time period between reception of the second DCI message and a last symbol of the additional message. In some examples, the monitoring time period extension manager 1630 may be configured as or otherwise support a means for communicating the additional message according to the extended monitoring time period.

In some examples, the ADU manager 1650 may be configured as or otherwise support a means for transmitting, during the first on duration, a DCI message scheduling an application data unit including a set of multiple downlink transmissions where the extended monitoring time period includes a last symbol of a last downlink transmission of the set of multiple transmissions.

In some examples, the DRX manager 1625 may be configured as or otherwise support a means for transmitting control signaling indicating an updated time interval for subsequent on durations of the discontinuous reception cycle, an updated time interval for the inactivity timer, or a combination thereof. In some examples, the DRX manager 1625 may be configured as or otherwise support a means for transmitting downlink signaling according to the updated time interval for the subsequent on duration, the updated time interval for the inactivity timer, or the combination thereof.

In some examples, the DRX manager 1625 may be configured as or otherwise support a means for receiving a report including one or more parameters associated with energy consumption at the UE, where transmitting the control signaling indicating the updated time interval for each on duration, the updated time interval for the inactivity timer, or the combination thereof, is based on reporting the one or more parameters.

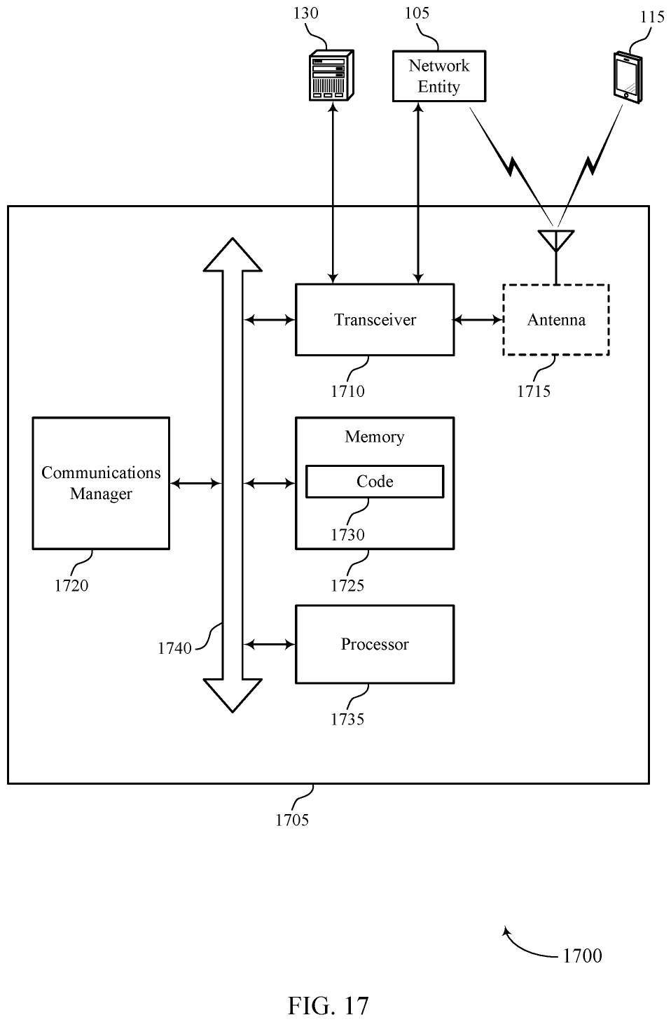

FIG. 17 shows a diagram of a system 1700 including a device 1705 that supports adaptable DRX cycles in accordance with one or more aspects of the present disclosure. The device 1705 may be an example of or include the components of a device 1405, a device 1505, or a network entity 105 as described herein. The device 1705 may communicate with one or more network entities 105, one or more UEs 115, or any combination thereof, which may include communications over one or more wired interfaces, over one or more wireless interfaces, or any combination thereof. The device 1705 may include components that support outputting and obtaining communications, such as a communications manager 1720, a transceiver 1710, an antenna 1715, a memory 1725, code 1730, and a processor 1735. These components may be in electronic communication or otherwise coupled (e.g., operatively, communicatively, functionally, electronically, electrically) via one or more buses (e.g., a bus 1740).

The transceiver 1710 may support bi-directional communications via wired links, wireless links, or both as described herein. In some examples, the transceiver 1710 may include a wired transceiver and may communicate bi-directionally with another wired transceiver. Additionally, or alternatively, in some examples, the transceiver 1710 may include a wireless transceiver and may communicate bi-directionally with another wireless transceiver. In some examples, the device 1705 may include one or more antennas 1715, which may be capable of transmitting or receiving wireless transmissions (e.g., concurrently). The transceiver 1710 may also include a modem to modulate signals, to provide the modulated signals for transmission (e.g., by one or more antennas 1715, by a wired transmitter), to receive modulated signals (e.g., from one or more antennas 1715, from a wired receiver), and to demodulate signals. In some implementations, the transceiver 1710 may include one or more interfaces, such as one or more interfaces coupled with the one or more antennas 1715 that are configured to support various receiving or obtaining operations, or one or more interfaces coupled with the one or more antennas 1715 that are configured to support various transmitting or outputting operations, or a combination thereof. In some implementations, the transceiver 1710 may include or be configured for coupling with one or more processors or memory components that are operable to perform or support operations based on received or obtained information or signals, or to generate information or other signals for transmission or other outputting, or any combination thereof. In some implementations, the transceiver 1710, or the transceiver 1710 and the one or more antennas 1715, or the transceiver 1710 and the one or more antennas 1715 and one or more processors or memory components (for example, the processor 1735, or the memory 1725, or both), may be included in a chip or chip assembly that is installed in the device 1705. In some examples, the transceiver may be operable to support communications via one or more communications links (e.g., a communication link 125, a backhaul communication link 120, a midhaul communication link 162, a fronthaul communication link 168).

The memory 1725 may include RAM and ROM. The memory 1725 may store computer-readable, computer-executable code 1730 including instructions that, when executed by the processor 1735, cause the device 1705 to perform various functions described herein. The code 1730 may be stored in a non-transitory computer-readable medium such as system memory or another type of memory. In some cases, the code 1730 may not be directly executable by the processor 1735 but may cause a computer (e.g., when compiled and executed) to perform functions described herein. In some cases, the memory 1725 may contain, among other things, a BIOS which may control basic hardware or software operation such as the interaction with peripheral components or devices.

The processor 1735 may include an intelligent hardware device (e.g., a general-purpose processor, a DSP, an ASIC, a CPU, a GPU, an FPGA, a microcontroller, a programmable logic device, discrete gate or transistor logic, a discrete hardware component, or any combination thereof). In some cases, the processor 1735 may be configured to operate a memory array using a memory controller. In some other cases, a memory controller may be integrated into the processor 1735. The processor 1735 may be configured to execute computer-readable instructions stored in a memory (e.g., the memory 1725) to cause the device 1705 to perform various functions (e.g., functions or tasks supporting adaptable DRX cycles). For example, the device 1705 or a component of the device 1705 may include a processor 1735 and memory 1725 coupled with the processor 1735, the processor 1735 and memory 1725 configured to perform various functions described herein. The processor 1735 may be an example of a cloud-computing platform (e.g., one or more physical nodes and supporting software such as operating systems, virtual machines, or container instances) that may host the functions (e.g., by executing code 1730) to perform the functions of the device 1705. The processor 1735 may be any one or more suitable processors capable of executing scripts or instructions of one or more software programs stored in the device 1705 (such as within the memory 1725). In some implementations, the processor 1735 may be a component of a processing system. A processing system may generally refer to a system or series of machines or components that receives inputs and processes the inputs to produce a set of outputs (which may be passed to other systems or components of, for example, the device 1705). For example, a processing system of the device 1705 may refer to a system including the various other components or subcomponents of the device 1705, such as the processor 1735, or the transceiver 1710, or the communications manager 1720, or other components or combinations of components of the device 1705. The processing system of the device 1705 may interface with other components of the device 1705, and may process information received from other components (such as inputs or signals) or output information to other components. For example, a chip or modem of the device 1705 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1705 may transmit information output from the chip or modem. Additionally, or alternatively, in some implementations, the one or more interfaces may refer to an interface between the processing system of the chip or modem and a receiver, such that the device 1705 may obtain information or signal inputs, and the information may be passed to the processing system. A person having ordinary skill in the art will readily recognize that a first interface also may obtain information or signal inputs, and a second interface also may output information or signal outputs.

In some examples, a bus 1740 may support communications of (e.g., within) a protocol layer of a protocol stack. In some examples, a bus 1740 may support communications associated with a logical channel of a protocol stack (e.g., between protocol layers of a protocol stack), which may include communications performed within a component of the device 1705, or between different components of the device 1705 that may be co-located or located in different locations (e.g., where the device 1705 may refer to a system in which one or more of the communications manager 1720, the transceiver 1710, the memory 1725, the code 1730, and the processor 1735 may be located in one of the different components or divided between different components).

In some examples, the communications manager 1720 may manage aspects of communications with a core network 130 (e.g., via one or more wired or wireless backhaul links). For example, the communications manager 1720 may manage the transfer of data communications for client devices, such as one or more UEs 115. In some examples, the communications manager 1720 may manage communications with other network entities 105, and may include a controller or scheduler for controlling communications with UEs 115 in cooperation with other network entities 105. In some examples, the communications manager 1720 may support an X2 interface within an LTE/LTE-A wireless communications network technology to provide communication between network entities 105.

The communications manager 1720 may support wireless communications at a network entity in accordance with examples as disclosed herein. For example, the communications manager 1720 may be configured as or otherwise support a means for transmitting, to a UE, control signaling indicating a first on duration of a discontinuous reception cycle. The communications manager 1720 may be configured as or otherwise support a means for transmitting, to the UE, one or more downlink messages during an extended monitoring time period associated with a detected trigger, the extended monitoring time period including a modified on duration, a modified inactivity timer for the UE, or a combination thereof.

By including or configuring the communications manager 1720 in accordance with examples as described herein, the device 1705 may support techniques for extending a monitoring time period resulting in increased power savings, more efficient use of available system resources, support for bursty communications such as XR communications, more reliable wireless communications, improved battery life, and improved user experience.

In some examples, the communications manager 1720 may be configured to perform various operations (e.g., receiving, obtaining, monitoring, outputting, transmitting) using or otherwise in cooperation with the transceiver 1710, the one or more antennas 1715 (e.g., where applicable), or any combination thereof. Although the communications manager 1720 is illustrated as a separate component, in some examples, one or more functions described with reference to the communications manager 1720 may be supported by or performed by the transceiver 1710, the processor 1735, the memory 1725, the code 1730, or any combination thereof. For example, the code 1730 may include instructions executable by the processor 1735 to cause the device 1705 to perform various aspects of adaptable DRX cycles as described herein, or the processor 1735 and the memory 1725 may be otherwise configured to perform or support such operations.

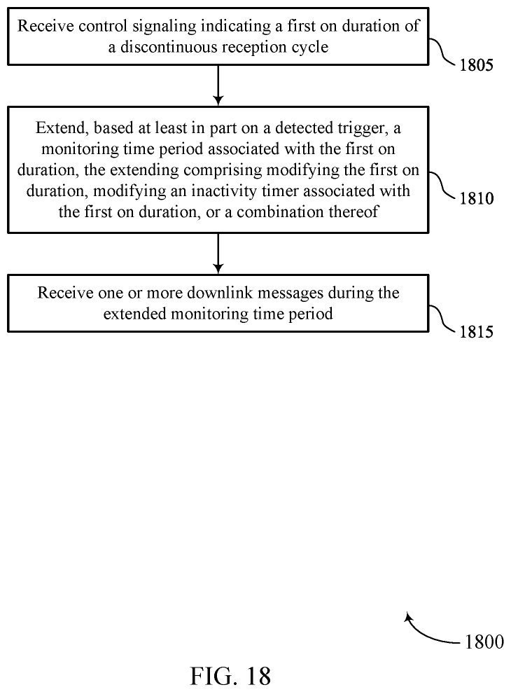

FIG. 18 shows a flowchart illustrating a method 1800 that supports adaptable DRX cycles in accordance with one or more aspects of the present disclosure. The operations of the method 1800 may be implemented by a UE or its components as described herein. For example, the operations of the method 1800 may be performed by a UE 115 as described with reference to FIGS. 1 through 13. In some examples, a UE may execute a set of instructions to control the functional elements of the UE to perform the described functions. Additionally, or alternatively, the UE may perform aspects of the described functions using special-purpose hardware.

At 1805, the method may include receiving control signaling indicating a first on duration of a discontinuous reception cycle. The operations of 1805 may be performed in accordance with examples as disclosed herein. In some examples, aspects of the operations of 1805 may be performed by a DRX manager 1225 as described with reference to FIG. 12.

At 1810, the method may include extending, based at least in part on a detected trigger, a monitoring time period associated with the first on duration, the extending including modifying the first on duration, modifying an inactivity timer associated with the first on duration, or a combination thereof. The operations of 1810 may be performed in accordance with examples as disclosed herein. In some examples, aspects of the operations of 1810 may be performed by a monitoring time period extension manager 1230 as described with reference to FIG. 12.

At 1815, the method may include receiving one or more downlink messages during the extended monitoring time period. The operations of 1815 may be performed in accordance with examples as disclosed herein. In some examples, aspects of the operations of 1815 may be performed by a monitoring manager 1235 as described with reference to FIG. 12.

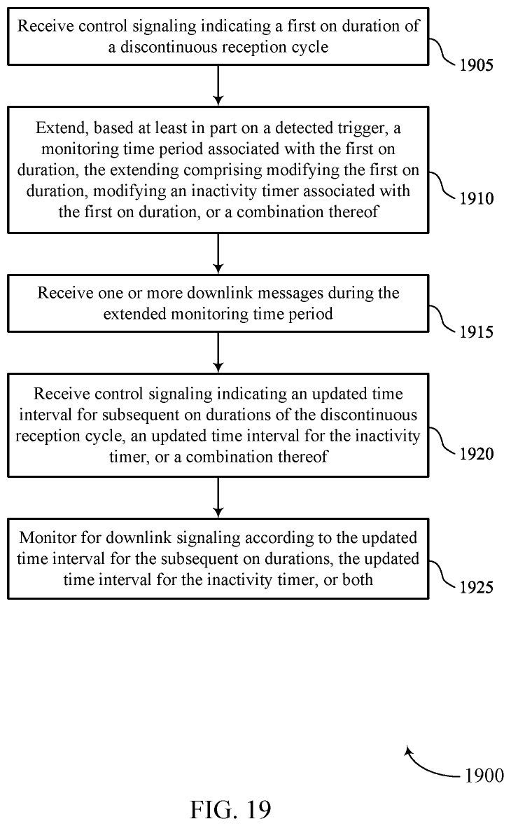

FIG. 19 shows a flowchart illustrating a method 1900 that supports adaptable DRX cycles in accordance with one or more aspects of the present disclosure. The operations of the method 1900 may be implemented by a UE or its components as described herein. For example, the operations of the method 1900 may be performed by a UE 115 as described with reference to FIGS. 1 through 13. In some examples, a UE may execute a set of instructions to control the functional elements of the UE to perform the described functions. Additionally, or alternatively, the UE may perform aspects of the described functions using special-purpose hardware.

At 1905, the method may include receiving control signaling indicating a first on duration of a discontinuous reception cycle. The operations of 1905 may be performed in accordance with examples as disclosed herein. In some examples, aspects of the operations of 1905 may be performed by a DRX manager 1225 as described with reference to FIG. 12.

At 1910, the method may include extending, based at least in part on a detected trigger, a monitoring time period associated with the first on duration, the extending including modifying the first on duration, modifying an inactivity timer associated with the first on duration, or a combination thereof. The operations of 1910 may be performed in accordance with examples as disclosed herein. In some examples, aspects of the operations of 1910 may be performed by a monitoring time period extension manager 1230 as described with reference to FIG. 12.

At 1915, the method may include receiving one or more downlink messages during the extended monitoring time period. The operations of 1915 may be performed in accordance with examples as disclosed herein. In some examples, aspects of the operations of 1915 may be performed by a monitoring manager 1235 as described with reference to FIG. 12.

At 1920, the method may include receiving control signaling indicating an updated time interval for subsequent on durations of the discontinuous reception cycle, an updated time interval for the inactivity timer, or a combination thereof. The operations of 1920 may be performed in accordance with examples as disclosed herein. In some examples, aspects of the operations of 1920 may be performed by a DRX manager 1225 as described with reference to FIG. 12.

At 1925, the method may include monitoring for downlink signaling according to the updated time interval for the subsequent on durations, the updated time interval for the inactivity timer, or both. The operations of 1925 may be performed in accordance with examples as disclosed herein. In some examples, aspects of the operations of 1925 may be performed by a DRX manager 1225 as described with reference to FIG. 12.

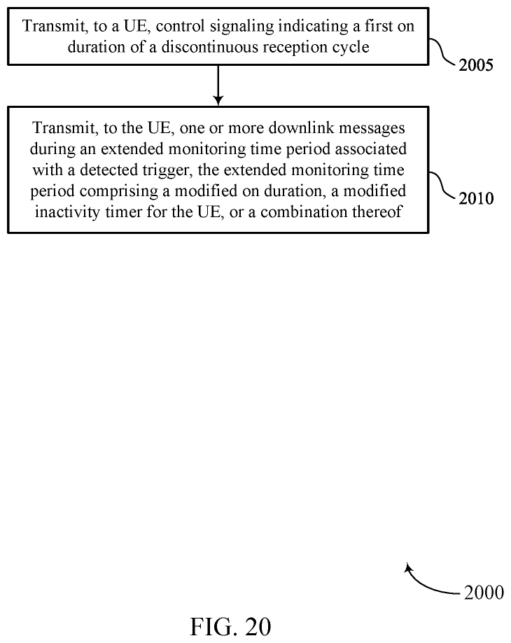

FIG. 20 shows a flowchart illustrating a method 2000 that supports adaptable DRX cycles in accordance with one or more aspects of the present disclosure. The operations of the method 2000 may be implemented by a network entity or its components as described herein. For example, the operations of the method 2000 may be performed by a network entity as described with reference to FIGS. 1 through 9 and 14 through 17. In some examples, a network entity may execute a set of instructions to control the functional elements of the network entity to perform the described functions. Additionally, or alternatively, the network entity may perform aspects of the described functions using special-purpose hardware.

At 2005, the method may include transmitting, to a UE, control signaling indicating a first on duration of a discontinuous reception cycle. The operations of 2005 may be performed in accordance with examples as disclosed herein. In some examples, aspects of the operations of 2005 may be performed by a DRX manager 1625 as described with reference to FIG. 16.

At 2010, the method may include transmitting, to the UE, one or more downlink messages during an extended monitoring time period associated with a detected trigger, the extended monitoring time period including a modified on duration, a modified inactivity timer for the UE, or a combination thereof. The operations of 2010 may be performed in accordance with examples as disclosed herein. In some examples, aspects of the operations of 2010 may be performed by a monitoring time period extension manager 1630 as described with reference to FIG. 16.

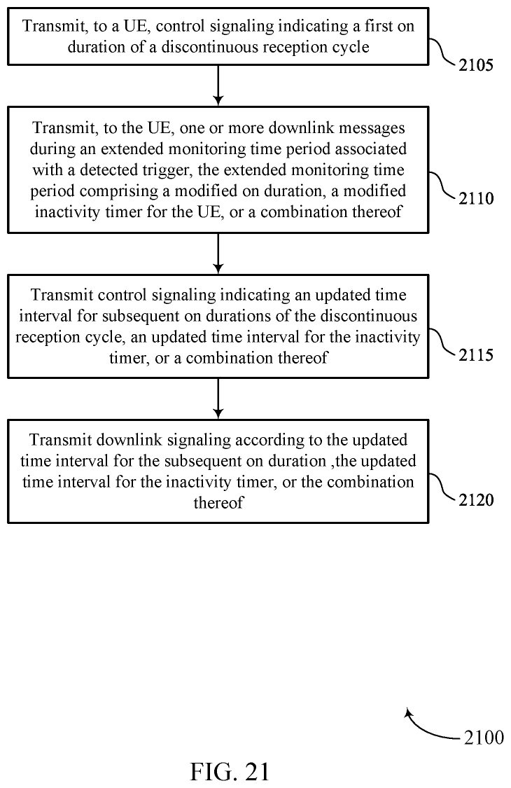

FIG. 21 shows a flowchart illustrating a method 2100 that supports adaptable DRX cycles in accordance with one or more aspects of the present disclosure. The operations of the method 2100 may be implemented by a network entity or its components as described herein. For example, the operations of the method 2100 may be performed by a network entity as described with reference to FIGS. 1 through 9 and 14 through 17. In some examples, a network entity may execute a set of instructions to control the functional elements of the network entity to perform the described functions. Additionally, or alternatively, the network entity may perform aspects of the described functions using special-purpose hardware.

At 2105, the method may include transmitting, to a UE, control signaling indicating a first on duration of a discontinuous reception cycle. The operations of 2105 may be performed in accordance with examples as disclosed herein. In some examples, aspects of the operations of 2105 may be performed by a DRX manager 1625 as described with reference to FIG. 16.

At 2110, the method may include transmitting, to the UE, one or more downlink messages during an extended monitoring time period associated with a detected trigger, the extended monitoring time period including a modified on duration, a modified inactivity timer for the UE, or a combination thereof. The operations of 2110 may be performed in accordance with examples as disclosed herein. In some examples, aspects of the operations of 2110 may be performed by a monitoring time period extension manager 1630 as described with reference to FIG. 16.

At 2115, the method may include transmitting control signaling indicating an updated time interval for subsequent on durations of the discontinuous reception cycle, an updated time interval for the inactivity timer, or a combination thereof. The operations of 2115 may be performed in accordance with examples as disclosed herein. In some examples, aspects of the operations of 2115 may be performed by a DRX manager 1625 as described with reference to FIG. 16.

At 2120, the method may include transmitting downlink signaling according to the updated time interval for the subsequent on duration, the updated time interval for the inactivity timer, or the combination thereof. The operations of 2120 may be performed in accordance with examples as disclosed herein. In some examples, aspects of the operations of 2120 may be performed by a DRX manager 1625 as described with reference to FIG. 16.

The following provides an overview of aspects of the present disclosure:

Aspect 1: A method for wireless communications at a UE, comprising: receiving control signaling indicating a first on duration of a discontinuous reception cycle; extending, based at least in part on a detected trigger, a monitoring time period associated with the first on duration, the extending comprising modifying the first on duration, modifying an inactivity timer associated with the first on duration, or a combination thereof; and receiving one or more downlink messages during the extended monitoring time period.

Aspect 2: The method of aspect 1, further comprising: receiving a first wakeup signal comprising the detected trigger, the first wakeup signal associated with the first on duration and comprising an indication of a time interval wherein extending the monitoring time period comprises extending the monitoring time period according to the indication of the time interval.

Aspect 3: The method of any of aspects 1 through 2, further comprising: receiving a control message, the control message comprising a first wakeup signal associated with the first on duration or a DCI message, and the control message further comprising an indication of a power threshold, wherein the detected trigger comprises a determination that one or more parameters satisfy the power threshold, wherein the one or more parameters comprise a UE charging rate, a UE discharging rate, a UE energy level, a power headroom, or a combination thereof.

Aspect 4: The method of aspect 3, further comprising: measuring the one or more parameters prior to expiration of the inactivity timer, prior to an offset from an end of a previous on duration of the discontinuous reception cycle, prior to an offset from a beginning of the first on duration, based on a current energy state calculation, or any combination thereof.

Aspect 5: The method of any of aspects 1 through 4, further comprising: receiving control signaling indicating a communication state, the control signaling comprising the detected trigger, wherein extending the monitoring time period is based at least in part on the communication state.

Aspect 6: The method of any of aspects 1 through 5, further comprising: receiving, during the first on duration, a DCI message comprising an indication of a time interval, the indication of the time interval comprising the detected trigger, wherein extending the monitoring time period comprises extending the monitoring time period according to the indication of the time interval.

Aspect 7: The method of any of aspects 1 through 6, further comprising: receiving control signaling indicating a threshold ratio between a quantity of downlink messages and a quantity of time intervals; and determining that a plurality of downlink messages during the first on duration satisfies the threshold ratio, the determining comprising the detected trigger, wherein extending the monitoring time period is based at least in part on receiving the plurality of downlink messages.

Aspect 8: The method of any of aspects 1 through 7, further comprising: receiving, during the first on duration, a DCI message scheduling at least one message comprising an uplink message or a downlink message after the first on duration; and selecting the greater of a first time period associated with the inactivity timer, or a second time period between reception of the DCI message and a last symbol of the scheduled at least one message, wherein extending the monitoring time period comprises extending the monitoring time period according to the selecting.

Aspect 9: The method of aspect 8, further comprising: receiving, based at least in part on extending the monitoring time period, a second DCI message scheduling an additional message comprising an uplink message or a downlink message after the first on duration; selecting the greater of a time interval associated with the inactivity timer, or a third time period between reception of the second DCI message and a last symbol of the additional message; further extending the monitoring time period according to the selected time interval or the third time period; and communicating the additional message according to the further extended monitoring time period.

Aspect 10: The method of aspect 9, further comprising: extending the monitoring time period according to the selecting comprises extending the on duration; and further extending the monitoring time period according to the time interval associated with the inactivity timer or the third time period comprises extending the inactivity timer.

Aspect 11: The method of any of aspects 1 through 10, further comprising: receiving, during the first on duration, a DCI message scheduling an application data unit comprising a plurality of downlink transmissions wherein extending the monitoring time period comprises extending the monitoring time period to a last symbol of a last downlink transmission of the plurality of downlink transmissions.

Aspect 12: The method of any of aspects 1 through 11, further comprising: receiving control signaling indicating an updated time interval for subsequent on durations of the discontinuous reception cycle, an updated time interval for the inactivity timer, or a combination thereof; and monitoring for downlink signaling according to the updated time interval for the subsequent on durations, the updated time interval for the inactivity timer, or both.

Aspect 13: The method of aspect 12, further comprising: reporting one or more parameters associated with energy consumption at the UE, wherein receiving the control signaling indicating the updated time interval for each on duration, the updated time interval for the inactivity timer, or the combination thereof, is based at least in part on reporting the one or more parameters.

Aspect 14: A method for wireless communications at a network entity, comprising: transmitting, to a UE, control signaling indicating a first on duration of a discontinuous reception cycle; and transmitting, to the UE, one or more downlink messages during an extended monitoring time period associated with a detected trigger, the extended monitoring time period comprising a modified on duration, a modified inactivity timer for the UE, or a combination thereof.

Aspect 15: The method of aspect 14, further comprising: transmitting a first wakeup signal comprising the detected trigger, the first wakeup signal associated with the first on duration and comprising an indication of a time interval, wherein the extended monitoring time period is based at least in part on the indication of the time interval.

Aspect 16: The method of any of aspects 14 through 15, further comprising: transmitting a control message, the control message comprising a first wakeup signal associated with the first on duration or a DCI message, the control message further comprising an indication of a power threshold, wherein the detected trigger comprises a determination that one or more parameters satisfy the power threshold, wherein the one or more parameters comprise a UE charging rate, a UE discharging rate, a UE energy level, a power headroom, or a combination thereof.

Aspect 17: The method of any of aspects 14 through 16, further comprising: transmitting control signaling indicating a communication state, the control signaling comprising the detected trigger, wherein the extended monitoring time period is based at least in part on the communication state.

Aspect 18: The method of any of aspects 14 through 17, further comprising: transmitting control signaling indicating a threshold ratio between a quantity of downlink messages and a quantity of time intervals; and determining that a plurality of downlink messages during the first on duration satisfies the threshold ratio, the determining comprising the detected trigger, wherein the extended monitoring time period is based at least in part on transmitting the plurality of downlink messages.

Aspect 19: The method of aspect 18, further comprising: transmitting, during the first on duration, a DCI message scheduling at least one message comprising an uplink message or a downlink message after the first on duration, wherein the extended monitoring time period is based at least in part on the greater of a first time period associated with the inactivity timer, or a second time period between reception of the DCI message and a last symbol of the scheduled at least one message.

Aspect 20: The method of any of aspects 14 through 19, further comprising: transmitting, based at least in part on the extended monitoring time period, a second DCI message scheduling an additional message comprising an uplink message or a downlink message after the first on duration, wherein the extended monitoring time period is based at least in part on the greater of a time interval associated with the inactivity timer, or a third time period between reception of the second DCI message and a last symbol of the additional message; and communicating the additional message according to the extended monitoring time period.

Aspect 21: The method of any of aspects 14 through 20, further comprising: transmitting, during the first on duration, a DCI message scheduling an application data unit comprising a plurality of downlink transmissions wherein the extended monitoring time period includes a last symbol of a last downlink transmission of the plurality of downlink transmissions.

Aspect 22: The method of any of aspects 14 through 21, further comprising: transmitting control signaling indicating an updated time interval for subsequent on durations of the discontinuous reception cycle, an updated time interval for the inactivity timer, or a combination thereof; and transmitting downlink signaling according to the updated time interval for the subsequent on duration, the updated time interval for the inactivity timer, or the combination thereof.

Aspect 23: The method of aspect 22, further comprising: receiving a report comprising one or more parameters associated with energy consumption at the UE, wherein transmitting the control signaling indicating the updated time interval for each on duration, the updated time interval for the inactivity timer, or the combination thereof, is based at least in part on reporting the one or more parameters.

Aspect 24: An apparatus for wireless communications at a UE, comprising a processor; memory coupled with the processor; and instructions stored in the memory and executable by the processor to cause the apparatus to perform a method of any of aspects 1 through 13.

Aspect 25: An apparatus for wireless communications at a UE, comprising at least one means for performing a method of any of aspects 1 through 13.

Aspect 26: A non-transitory computer-readable medium storing code for wireless communications at a UE, the code comprising instructions executable by a processor to perform a method of any of aspects 1 through 13.

Aspect 27: An apparatus for wireless communications at a network entity, comprising a processor; memory coupled with the processor; and instructions stored in the memory and executable by the processor to cause the apparatus to perform a method of any of aspects 14 through 23.

Aspect 28: An apparatus for wireless communications at a network entity, comprising at least one means for performing a method of any of aspects 14 through 23.

Aspect 29: A non-transitory computer-readable medium storing code for wireless communications at a network entity, the code comprising instructions executable by a processor to perform a method of any of aspects 14 through 23.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a GPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, or any combination thereof. Software shall be construed broadly to mean instructions, instruction sets, code, code segments, program code, programs, subprograms, software modules, applications, software applications, software packages, routines, subroutines, objects, executables, threads of execution, procedures, or functions, whether referred to as software, firmware, middleware, microcode, hardware description language, or otherwise. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, phase change memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (e.g., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communications at a user equipment (UE), comprising:
at least one processor; and
memory coupled to the at least one processor, the memory storing instructions executable by the at least one processor to cause the UE to:
receive control signaling indicating a first on duration of a discontinuous reception cycle;
extend, based at least in part on a detected trigger, a monitoring time period associated with the first on duration, the extending comprising modifying the first on duration, modifying an inactivity timer associated with the first on duration, or a combination thereof, and
receive one or more downlink messages during the extended monitoring time period.

2. The apparatus of claim 1, wherein the instructions are further executable by the at least one processor to cause the UE to:
receive a first wakeup signal comprising the detected trigger, the first wakeup signal associated with the first on duration and comprising an indication of a time interval wherein extending the monitoring time period comprises extending the monitoring time period according to the indication of the time interval.

3. The apparatus of claim 1, wherein the instructions are further executable by the at least one processor to cause the UE to:
receive a control message, the control message comprising a first wakeup signal associated with the first on duration or a downlink control information message, and the control message further comprising an indication of a power threshold, wherein the detected trigger comprises a determination that one or more parameters satisfy the power threshold, wherein the one or more parameters comprise a UE charging rate, a UE discharging rate, a UE energy level, a power headroom, or a combination thereof.

4. The apparatus of claim 3, wherein the instructions are further executable by the at least one processor to cause the UE to:
measure the one or more parameters prior to expiration of the inactivity timer, prior to an offset from an end of a previous on duration of the discontinuous reception cycle, prior to an offset from a beginning of the first on duration, based on a current energy state calculation, or any combination thereof.

5. The apparatus of claim 1, wherein the instructions are further executable by the at least one processor to cause the UE to:
receive control signaling indicating a communication state, the control signaling comprising the detected trigger, wherein extending the monitoring time period is based at least in part on the communication state.

6. The apparatus of claim 1, wherein the instructions are further executable by the at least one processor to cause the UE to:
receive, during the first on duration, a downlink control information message comprising an indication of a time interval, the indication of the time interval comprising the detected trigger, wherein extending the monitoring time period comprises extending the monitoring time period according to the indication of the time interval.

7. The apparatus of claim 1, wherein the instructions are further executable by the at least one processor to cause the UE to:
receive control signaling indicating a threshold ratio between a quantity of downlink messages and a quantity of time intervals; and
determine that a plurality of downlink messages during the first on duration satisfies the threshold ratio, the determining comprising the detected trigger, wherein extending the monitoring time period is based at least in part on receiving the plurality of downlink messages.

8. The apparatus of claim 1, wherein the instructions are further executable by the at least one processor to cause the UE to:
receive, during the first on duration, a downlink control information message scheduling at least one message comprising an uplink message or a downlink message after the first on duration; and
select the greater of a first time period associated with the inactivity timer, or a second time period between reception of the downlink control information message and a last symbol of the scheduled at least one message, wherein extending the monitoring time period comprises extending the monitoring time period according to the selecting.

9. The apparatus of claim 8, wherein the instructions are further executable by the at least one processor to cause the UE to:
receive, based at least in part on extending the monitoring time period, a second downlink control information message scheduling an additional message comprising an uplink message or a downlink message after the first on duration;
select the greater of a time interval associated with the inactivity timer, or a third time period between reception of the second downlink control information message and a last symbol of the additional message;
further extend the monitoring time period according to the selected time interval or the third time period; and
communicate the additional message according to the further extended monitoring time period.

10. The apparatus of claim 9, wherein the instructions are further executable by the at least one processor to cause the UE to:
extend the monitoring time period according to the selecting comprises extending the on duration; and
further extend the monitoring time period according to the time interval associated with the inactivity timer or the third time period comprises extending the inactivity timer.

11. The apparatus of claim 1, wherein the instructions are further executable by the at least one processor to cause the UE to:
receive, during the first on duration, a downlink control information message scheduling an application data unit comprising a plurality of downlink transmissions wherein extending the monitoring time period comprises extending the monitoring time period to a last symbol of a last downlink transmission of the plurality of downlink transmissions.

12. The apparatus of claim 1, wherein the instructions are further executable by the at least one processor to cause the UE to:
receive control signaling indicating an updated time interval for subsequent on durations of the discontinuous reception cycle, an updated time interval for the inactivity timer, or a combination thereof; and
monitor for downlink signaling according to the updated time interval for the subsequent on durations, the updated time interval for the inactivity timer, or both.

13. The apparatus of claim 12, wherein the instructions are further executable by the at least one processor to cause the UE to:
report one or more parameters associated with energy consumption at the UE, wherein receiving the control signaling indicating the updated time interval for each on duration, the updated time interval for the inactivity timer, or the combination thereof, is based at least in part on reporting the one or more parameters.

14. An apparatus for wireless communications at a network entity, comprising:
at least one processor; and
memory coupled to the at least one processor, the memory storing instructions executable by the at least one processor to cause the network entity to:
transmit, to a user equipment (UE), control signaling indicating a first on duration of a discontinuous reception cycle; and
transmit, to the UE, one or more downlink messages during an extended monitoring time period associated with a detected trigger, the extended monitoring time period comprising a modified on duration, a modified inactivity timer for the UE, or a combination thereof.

15. The apparatus of claim 14, wherein the instructions are further executable by the at least one processor to cause the UE to:
transmit a first wakeup signal comprising the detected trigger, the first wakeup signal associated with the first on duration and comprising an indication of a time interval, wherein the extended monitoring time period is based at least in part on the indication of the time interval.

16. The apparatus of claim 14, wherein the instructions are further executable by the at least one processor to cause the UE to:
transmit a control message, the control message comprising a first wakeup signal associated with the first on duration or a downlink control information message, the control message further comprising an indication of a power threshold, wherein the detected trigger comprises a determination that one or more parameters satisfy the power threshold, wherein the one or more parameters comprise a UE charging rate, a UE discharging rate, a UE energy level, a power headroom, or a combination thereof.

17. The apparatus of claim 14, wherein the instructions are further executable by the at least one processor to cause the UE to:
transmit control signaling indicating a communication state, the control signaling comprising the detected trigger, wherein the extended monitoring time period is based at least in part on the communication state.

18. The apparatus of claim 14, wherein the instructions are further executable by the at least one processor to cause the UE to:
transmit control signaling indicating a threshold ratio between a quantity of downlink messages and a quantity of time intervals; and
determine that a plurality of downlink messages during the first on duration satisfies the threshold ratio, the determining comprising the detected trigger, wherein the extended monitoring time period is based at least in part on transmitting the plurality of downlink messages.

19. The apparatus of claim 18, wherein the instructions are further executable by the at least one processor to cause the UE to:
transmit, during the first on duration, a downlink control information message scheduling at least one message comprising an uplink message or a downlink message after the first on duration, wherein the extended monitoring time period is based at least in part on the greater of a first time period associated with the inactivity timer, or a second time period between reception of the downlink control information message and a last symbol of the scheduled at least one message.

20. The apparatus of claim 14, wherein the instructions are further executable by the at least one processor to cause the UE to:
transmit, based at least in part on the extended monitoring time period, a second downlink control information message scheduling an additional message comprising an uplink message or a downlink message after the first on duration, wherein the extended monitoring time period is based at least in part on the greater of a time interval associated with the inactivity timer, or a third time period between reception of the second downlink control information message and a last symbol of the additional message; and
communicate the additional message according to the extended monitoring time period.

21. The apparatus of claim 14, wherein the instructions are further executable by the at least one processor to cause the UE to:
transmit, during the first on duration, a downlink control information message scheduling an application data unit comprising a plurality of downlink transmissions wherein the extended monitoring time period includes a last symbol of a last downlink transmission of the plurality of downlink transmissions.

22. The apparatus of claim 14, wherein the instructions are further executable by the at least one processor to cause the UE to:
transmit control signaling indicating an updated time interval for subsequent on durations of the discontinuous reception cycle, an updated time interval for the inactivity timer, or a combination thereof; and
transmit downlink signaling according to the updated time interval for the subsequent on duration, the updated time interval for the inactivity timer, or the combination thereof.

23. The apparatus of claim 22, wherein the instructions are further executable by the at least one processor to cause the UE to:
receive a report comprising one or more parameters associated with energy consumption at the UE, wherein transmitting the control signaling indicating the updated time interval for each on duration, the updated time interval for the inactivity timer, or the combination thereof, is based at least in part on reporting the one or more parameters.

24. A method for wireless communications at a user equipment (UE), comprising:
receiving control signaling indicating a first on duration of a discontinuous reception cycle;
extending, based at least in part on a detected trigger, a monitoring time period associated with the first on duration, the extending comprising modifying the first on duration, modifying an inactivity timer associated with the first on duration, or a combination thereof; and
receiving one or more downlink messages during the extended monitoring time period.

25. The method of claim 24, further comprising:
receiving a first wakeup signal comprising the detected trigger, the first wakeup signal associated with the first on duration and comprising an indication of a time interval wherein extending the monitoring time period comprises extending the monitoring time period according to the indication of the time interval.

26. The method of claim 24, further comprising:
receiving a control message, the control message comprising a first wakeup signal associated with the first on duration or a downlink control information message, and the control message further comprising an indication of a power threshold, wherein the detected trigger comprises a determination that one or more parameters satisfy the power threshold, wherein the one or more parameters comprise a UE charging rate, a UE discharging rate, a UE energy level, a power headroom, or a combination thereof.

27. The method of claim 26, further comprising:
measuring the one or more parameters prior to expiration of the inactivity timer, prior to an offset from an end of a previous on duration of the discontinuous reception cycle, prior to an offset from a beginning of the first on duration, based on a current energy state calculation, or any combination thereof.

28. The method of claim 24, further comprising:
receiving control signaling indicating a communication state, the control signaling comprising the detected trigger, wherein extending the monitoring time period is based at least in part on the communication state.

29. The method of claim 24, further comprising:
receiving, during the first on duration, a downlink control information message comprising an indication of a time interval, the indication of the time interval comprising the detected trigger, wherein extending the monitoring time period comprises extending the monitoring time period according to the indication of the time interval.

30. A method for wireless communications at a network entity, comprising:
transmitting, to a user equipment (UE), control signaling indicating a first on duration of a discontinuous reception cycle; and
transmitting, to the UE, one or more downlink messages during an extended monitoring time period associated with a detected trigger, the extended monitoring time period comprising a modified on duration, a modified inactivity timer for the UE, or a combination thereof.
